(19) United States
(12) Patent Application Publication
(10) Pub. No.: US 2018/0204522 A1
(43) Pub. Date: Jul. 19, 2018

(54) DISPLAY DRIVER WITH GAMMA CORRECTION

(71) Applicant: Synaptics Japan GK, Tokyo (JP)

(72) Inventors: Hirobumi FURIHATA, Tokyo (JP); Kazutoshi AOGAKI, Tokyo (JP); Takashi NOSE, Tokyo (JP)

(21) Appl. No.: 15/868,307

(22) Filed: Jan. 11, 2018

(30) Foreign Application Priority Data
Jan. 13, 2017 (JP) 2017004518

(51) Int. Cl. G09G 3/3275

(52) U.S. Cl. CPC G09G 3/3275; G09G 2320/0276; G09G 2320/0673; G09G 2300/0452; G09G 2310/027; G09G 2320/0626

(57) ABSTRACT

A system and method for controlling the screen brightness of a display comprising calculating a brightness data which specifies a screen brightness level of a self-luminous display panel, determining, based on the brightness data, correction control points, calculating an output value from the input grayscale value with input-output characteristics specified by the correction control points.

### CROSS REFERENCE

This application claims priority of Japanese Patent Application No. 2017-004518, filed on Jan. 13, 2017, the disclosure of which is incorporated herein by reference.

### TECHNICAL FIELD

The present disclosure relates to a display driver, a display device and a driving method, more particularly, to image data processing adapted to drive a self-luminous display panel such as OLED (organic light emitting diode) display panels.

### BACKGROUND ART

In many common implementations, a display driver driving a display panel is configured to perform gamma correction matching the characteristics of the display panel. The gamma correction may include image data processing performed to correctly display an image with brightness levels corresponding to the grayscale values specified by image data. Generally, the correspondence relation between the brightness levels of subpixels (R subpixels, G subpixels and B subpixels) and the signal levels of drive signals (drive voltages or drive currents) is not linear in the display panel. For example, the voltage-transparency curve (V-T curve) of a liquid crystal display panel may not be linear. Accordingly, in various implementations, supplying drive signals proportional to the grayscale values specified by display data does not achieve displaying an image with correct brightness levels.

However, gamma correction may be performed to display an image on such a display panel with the brightness levels corresponding to the specified grayscale values.

Additionally, in various implementations, a display driver which drives a self-luminous display panel such as OLED (organic light emitting diode) display panels is adapted to perform image data processing for controlling the screen brightness level in concurrence with gamma correction. In general, a display device has the function of adjusting the screen brightness level (that is, the brightness level of the entire displayed image). This function allows the display device to increase the screen brightness level through a manual operation, when a user desires to display a brighter image, for example.

For a display device including a backlight, such as liquid crystal display panels, in various implementations, it is not necessary to perform image data processing for controlling the screen brightness level, because the screen brightness level can be adjusted by the brightness of the backlight. In driving a self-luminous display panel such as OLED display panels, in contrast, the signal levels of the drive signals supplied to the respective subpixels of the respective pixels are controlled to control the screen brightness level. Accordingly, image data processing may be performed on image data to control the screen brightness level in driving a self-luminous display panel.

In one or more implementations, a display driver driving a self-luminous display panel may include a gamma correction circuitry which performs processing for controlling the screen brightness level in concurrence with gamma correction. Such gamma correction circuitry may however may increase the circuit size and/or decrease in the number of representable grayscale levels.

### SUMMARY

In one embodiment, a display driver includes: a correction circuitry configured to calculate an output value from an input grayscale value and a brightness data which specifies a screen brightness level of a self-luminous display panel; and a drive circuitry configured to generate a drive signal driving a light-emitting element of the self-luminous display panel in response to the output value. The correction circuitry is configured to determine, based on the brightness data, correction control points used for correction performed on the input grayscale value for the screen brightness level specified by the brightness data, and calculate the output value from the input grayscale value with input-output characteristics specified by the correction control points.

In another embodiment, a display device includes a self-luminous display panel in which each pixel circuit includes a light-emitting element; and a display driver driving the self-luminous display panel. The display driver includes: a correction circuitry configured to calculate an output value from an input grayscale value and a brightness data which specifies a screen brightness level of the self-luminous display panel; and a drive circuitry configured to generate a drive signal driving the light-emitting element of the self-luminous display panel in response to the output value. The correction circuitry is configured to determine, based on the brightness data, correction control points used for correction performed on the input grayscale value for the screen brightness level specified by the brightness data, and calculate the output value from the input grayscale value with input-output characteristics specified by the correction control points.

In still another embodiment, a method includes: calculating an output value from an input grayscale value and a brightness data which specifies a screen brightness level of a self-luminous display panel in which each pixel circuit includes a light-emitting element; and generating a drive signal driving the light-emitting element of the self-luminous display panel in response to the output value. The step of calculating the output value includes: determining, based on the brightness data, correction control points used for correction performed on the input grayscale value for the screen brightness level specified by the brightness data; and calculating the output value from the input grayscale value with input-output characteristics specified by the correction control points.

### BRIEF DESCRIPTION OF THE DRAWINGS

FIG. 1 is a graph illustrating the corresponding brightness levels to be achieved through gamma correction according to one or more embodiments;

FIG. 2 is a graph illustrating input-output characteristics of gamma correction for screen brightness levels according to one or more embodiments;

FIG. 3 is a block diagram of a gamma correction circuitry according to one or more embodiments;

FIG. 4 is a graph illustrating a decrease in the number of representable grayscale levels in a gamma correction circuitry illustrated according to one or more embodiments;

FIG. 5 is a block diagram illustrating a configuration of a display device according to one or more embodiments;

FIG. 6 is a block diagram illustrating a configuration of a display driver according to one or more embodiments;

FIG. 7 is a graph illustrating input-output characteristics of gamma correction according to one or more embodiments;

FIG. 8 is a graph illustrating the input-output characteristics of gamma correction according to one or more embodiments;

FIG. 9 is a block diagram illustrating a configuration of a gamma correction circuitry according to one or more embodiments;

FIG. 10 is a flowchart illustrating operation of gamma correction circuitry according to one or more embodiments;

FIG. 11 illustrates a Bezier curve calculation circuitry according to one or more embodiments;

FIG. 12 is a flowchart illustrating a calculation procedure performed in Bezier curve calculation circuitry according to one or more embodiments;

FIG. 13 is a block diagram illustrating one example of the configuration of a Bezier curve calculation circuitry according to one or more embodiments;

FIG. 14 is a circuit diagram illustrating the configuration of the processing units of the Bezier curve calculation circuitry according to one or more embodiments;

FIG. 15 illustrates a Bezier curve calculation circuitry according to one or more embodiments;

FIG. 16 is a block diagram illustrating an example configuration of a Bezier curve calculation circuitry according to one or more embodiments;

FIG. 17 is a circuit diagram illustrating configurations of an initial-stage processing unit and processing units of the Bezier curve calculation circuitry according to one or more embodiments; and

FIG. 18 schematically illustrates a Bezier curve calculation circuitry according to one or more embodiments.

### DETAILED DESCRIPTION

In the following, a description is given of various embodiments.

In one embodiment, a display driver configured for driving a self-luminous display drive is adapted to perform image data processing for controlling the screen brightness level in concurrence with gamma correction. A self-luminous display panel referred herein includes a display panel in which a pixel circuit constituting a subpixel of each pixel includes a light emitting element, such as OLED display panel. In one embodiment of an OLED display panel, each pixel includes a red subpixel, a green subpixel and a blue subpixel which include light emitting elements emitting red light, green light and blue light, respectively. In other embodiments, each pixel may include other subpixel colors in addition to red, green and blue subpixels. For example, pixels may additionally include white subpixels. Further, in yet other embodiments, each pixel may include other subpixel colors alternatively to red, green, and/or blue subpixels.

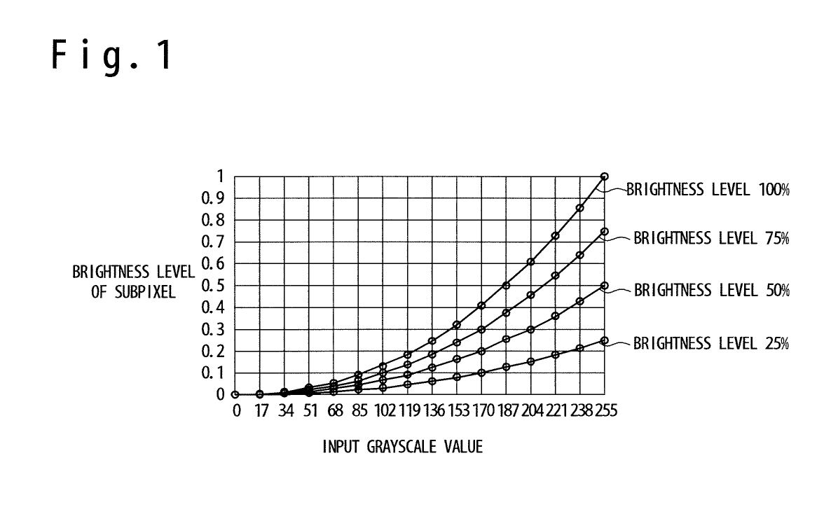

FIG. 1 illustrates one embodiment of the correspondence relation between the input grayscale value and the brightness levels of each subpixel to be achieved by ideal gamma characteristics of a display panel, for each screen brightness level. The legend “brightness level 100%” indicates a graph illustrating the gamma characteristics for the case where the screen brightness level is the allowed maximum brightness level (100%), and the legend “brightness level 75%” indicates a graph illustrating the gamma characteristics for the case where the screen brightness level is 75% of the allowed maximum brightness level. Similarly, the legend “brightness level 50%” indicates a graph illustrating the gamma characteristics for the case where the screen brightness level is 50% of the allowed maximum brightness level and the legend “brightness level 25%” indicates a graph illustrating the gamma characteristics for the case where the screen brightness level is 25% of the allowed maximum brightness level.

In FIG. 1, the graphs are normalized based on the brightness level of a subpixel being 1.0 when the input grayscale value associated with the subpixel is the allowed maximum value (255 in FIG. 1) for the case where the screen brightness level is the maximum brightness level (the brightness level of 100%). For the screen brightness level of 100%, for example, the ideal brightness level of a certain subpixel is 0.5 when the input grayscale value associated with this subpixel is 186.

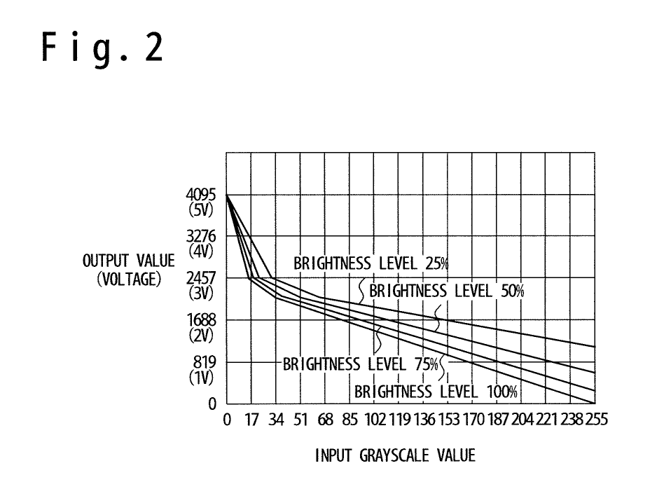

In one embodiment, the input-output characteristics of the gamma correction are modified in response to the screen brightness level. Further, processing for controlling the screen brightness level may be performed in concurrence with gamma correction. FIG. 2 is a graph illustrating one example of ideal input-output characteristics of the gamma correction for each screen brightness level. Illustrated in FIG. 2 are the input-output characteristics of the gamma correction for each screen brightness level when display data used to drive an OLED display panel through voltage programming are generated. In FIG. 2, the graph of the input-output characteristics is drawn with an assumption that the value of the display data (that is, the output value of the gamma correction) is a 12-bit value and each subpixel of each pixel of the OLED display panel is programmed with a voltage proportional to the value of the display data. When the output value is “4095”, for example, the subpixel of interest is programmed with a voltage of 5V. It should be noted that the brightness level of the subpixel is increased as the drive voltage is decreased, when an OLED display panel is driven through voltage programming.

With reference to FIG. 2, the shape of the input-output characteristics curve of the gamma correction depends on the screen brightness level due to the gamma characteristics of the display panel. For example, the input grayscale value at which the input-output characteristics curve is bent depends on the screen brightness level. More specifically, in the example illustrated in FIG. 2, the input-output characteristics curve is bent at input grayscale values of “17” and “34” for a screen brightness level of 100%, while the input-output characteristics curve is bent at input grayscale values of “30” and “66” for a screen brightness level of 25%.

The dependency of the input-output characteristics curve on the screen brightness level may cause a problem of an undesired increase in the circuit size of a gamma correction circuitry which performs processing for controlling the screen brightness level in concurrence with gamma correction. For example, a one approach to achieve processing for controlling the screen brightness level in concurrence with gamma correction is to prepare an LUT (lookup table) corresponding to the input-output characteristics for each screen brightness level. However, in various embodiments, preparing an LUT (lookup table) corresponding to the input-output characteristics for each screen brightness level may undesirably increase the circuit size of the gamma correction circuitry, because an LUT has a large circuit size.

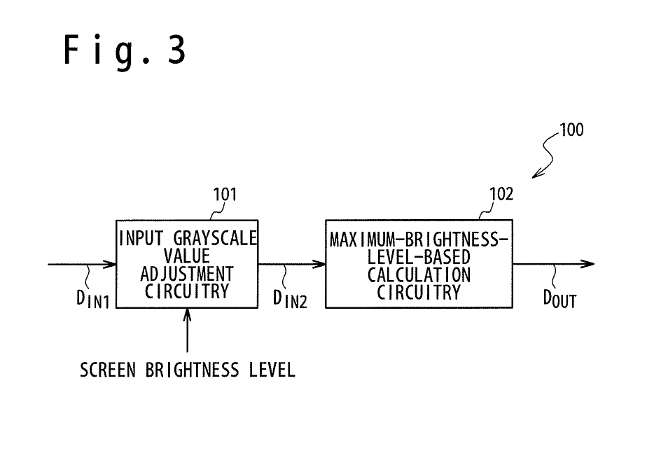

One possible approach to avoid an increase in the circuit size of a gamma correction circuitry may be to provide a processing circuitry (such as an LUT) which achieves the input-output characteristics of gamma correction for the allowed maximum screen brightness level and to adjust the input grayscale value supplied to the processing circuitry in response to the screen brightness level. FIG. 3 is a block diagram illustrating the configuration of a gamma correction circuitry 100 thus configured. It should be noted that the Applicant does not acknowledge that the configuration of the gamma correction circuitry 100 illustrated in FIG. 3 is publically known in the art.

The gamma correction circuitry 100 illustrated in FIG. 3 includes an input grayscale value adjustment circuitry 101 and a maximum-brightness-level-based calculation circuitry 102. The input grayscale value adjustment circuitry 101 calculates an input grayscale value D_{IN2} to be supplied to the maximum-brightness-level-based calculation circuitry 102 on the basis of the screen brightness level and an input grayscale value D_{IN1} externally supplied to the gamma correction circuitry 100. The maximum-brightness-level-based calculation circuitry 102 provides the input-output characteristics of the gamma correction for the allowed screen maximum brightness level (a screen brightness level of 100%). In one embodiments, when receiving the input grayscale value D_{IN2}, the allowed maximum-brightness-level-based calculation circuitry 102 outputs an output value D_{OUT} corresponding to the input grayscale value D_{IN2} in accordance with the input-output characteristics of the gamma correction for the maximum screen brightness level (the screen brightness level of 100%). For example, the maximum-brightness-level-based calculation circuitry 102 may output the output value D_{OUT} corresponding to the input grayscale value D_{IN2} in accordance with the input-output relationship defined by the graph indicated by “brightness level 100%” in FIG. 2. Such operation can be achieved by using an LUT as the maximum-brightness-level-based calculation circuitry 102, for example.

When the gamma value of the gamma correction is γ and the screen brightness level is q times (where 0≤q<1) of the allowed maximum brightness level, the following expression (1a) holds for the input grayscale value D_{IN1} of the gamma correction circuitry 100 and the input grayscale value D_{IN2} to be supplied to the maximum-brightness-level-based calculation circuitry 102:

D_{IN2}^{γ}=q·D_{IN1}^{γ} (1a)

The following expression (1b) can be obtained from expression (1a):

D_{IN2}=q^{1/γ}·D_{IN1} (1b)

In one embodiment, when the gamma value γ of the display panel is 2.2 and the screen brightness level is 0.5 times of the allowed maximum brightness level (a screen brightness level of 50%), for example, the following expression (1c) is obtained from expression (1b):

$$\begin{matrix}{D}_{IN 2} = {0.5}^{\frac{1}{2.2}} \cdot {D}_{IN 1} \\ \approx ( \frac{186}{255} ) \cdot {D}_{IN 1}\end{matrix} \qquad ( 1 c )$$

Expression (1c) implies that, for the gamma value γ of 2.2, the input-output characteristics of the gamma correction for a screen brightness level of 50% can be achieved by supplying the value obtained as (186/255) times of the input grayscale value D_{IN1} to the maximum-brightness-level-based calculation circuitry 102. In various embodiments, when the gamma value is γ and the screen brightness level is q times of the allowed maximum brightness level, gamma correction for a screen brightness level of q times of the allowed maximum brightness level can be achieved by supplying the value obtained as q^{1/γ} times of the input grayscale value D_{IN1}.

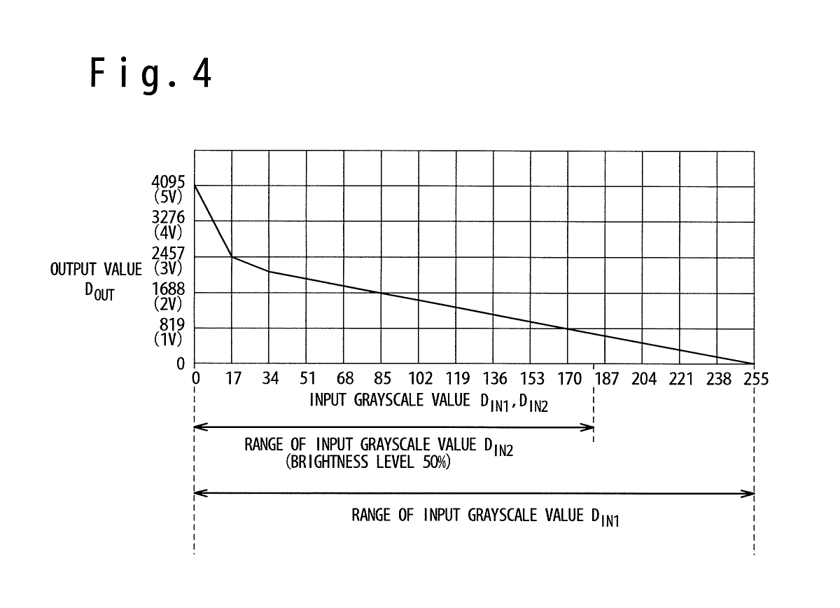

This approach however may lead to a decrease in the number of representable grayscale levels. This is because, as illustrated in FIG. 4, the allowed range of the input grayscale value D_{IN2} is restricted to or below q^{1/γ} times of the allowed maximum value D_{IN}^{MAX} of the input grayscale value D_{IN1} in the configuration in which the input grayscale value D_{IN2} obtained as q^{1/γ} times of the input grayscale value D_{IN1} is supplied to the maximum-brightness-level-based calculation circuitry 102. When the input grayscale value D_{IN1} is an 8-bit value, the allowed maximum value D_{IN}^{MAX} of the input grayscale value D_{IN1} is 255 (=2⁸−1). When the screen brightness level is 0.5 times of the allowed maximum brightness level (a screen brightness level of 50%), for example, the input grayscale value D_{IN2} obtained as (186/255) times of the input grayscale value D_{IN1} is supplied to the maximum-brightness-level-based calculation circuitry 102; however, the input grayscale value D_{IN2} supplied to the brightness-level-based calculation circuitry 102 is restricted to the range from zero to 186. This means that the number of representable grayscale levels is decreased.

In one or more of the following embodiments, gamma correction circuitries configured to suppress an increase in the circuit size and avoid the problem of a decrease in the number of representable grayscale levels, and applications of the gamma correction circuitries thus configured are described.

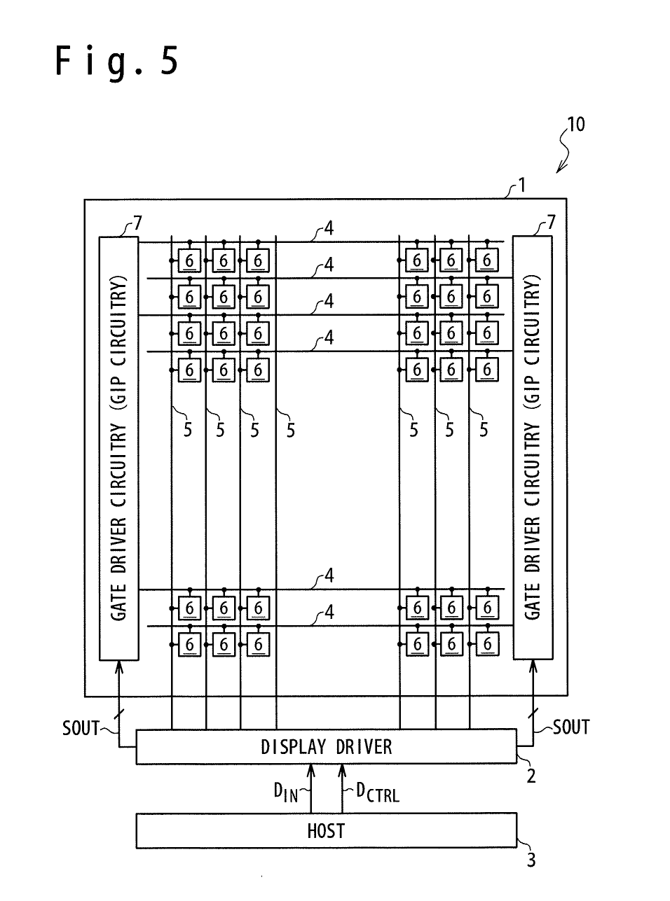

FIG. 5 is a block diagram illustrating the configuration of a display device 10 in one embodiment. The display device 10 is configured as an OLED display device including an OLED display panel 1 and a display driver 2.

The OLED display panel 1 includes gate lines 4, data lines 5, pixel circuits 6 and gate driver circuitries 7. Each of the pixel circuits 6 is disposed at an intersection of a gate line 4 and a data line 5 and includes a light emitting element emitting light of red, green or blue. Pixel circuits 6 including a light emitting element emitting red light are used as R subpixels. Similarly, pixel circuits 6 including a light emitting element emitting green light are used as G subpixels and pixel circuits 6 including a light emitting element emitting blue light are used as B subpixels. The gate driver circuitries 7 drive the gate lines 4 in response to gate control signals SOUT received from the display driver 2. In this embodiment, a pair of gate driver circuitries 7 is provided. One of the gate driver circuitries 7 drives the odd-numbered gate lines 4 and the other drives the even-numbered gate lines 4.

The display driver 2 drives the OLED display panel 1 in response to image data D_{IN} and control data D_{CTRL} received from a host 3, to display an image on the OLED display panel 1. The image data D_{IN} describe the grayscale value of each subpixel of each pixel of the OLED display panel 1. The control data D_{CTRL} include commands and parameters used for controlling the display driver 2. An application processor, a CPU (central processing unit), a DSP (digital signal processor) or the like may be used as the host 3.

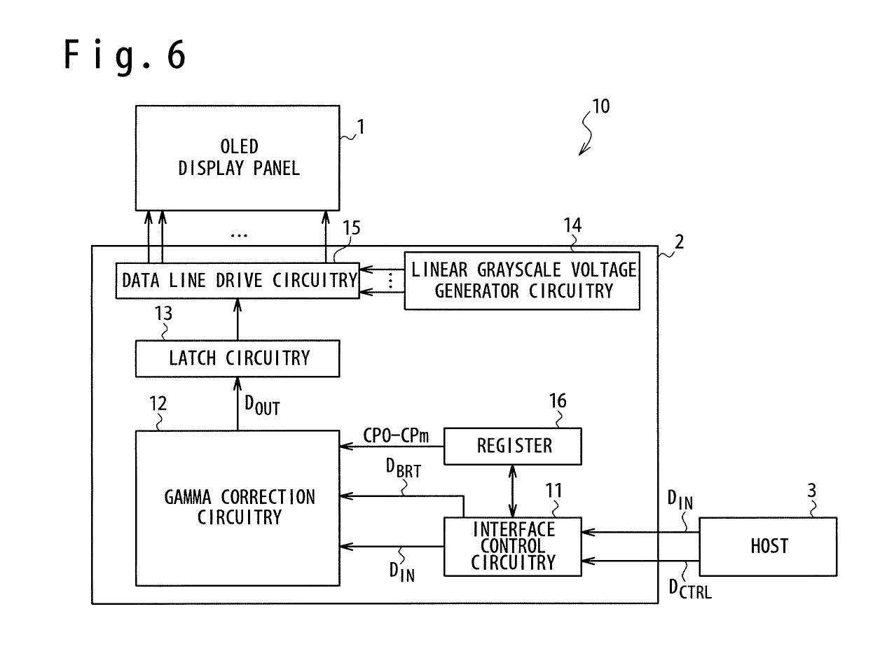

FIG. 6 is a block diagram illustrating the configuration of the display driver 2 in one embodiment. The display driver 2 includes an interface control circuitry 11, a gamma correction circuitry 12, a latch circuitry 13, a linear grayscale voltage generator circuitry 14, a data line drive circuitry 15 and a register 16.

The interface control circuitry 11 operates as follows. The interface control circuitry 11 forwards the image data D_{IN} received from the host 3 to the gamma correction circuitry 12. The interface control circuitry 11 also stores various control parameters into the register 16 and controls the respective circuitries of the display driver 2 in response to commands included in the control data D_{CTRL}. The control parameters stored in the register 16 include parameters used for controlling gamma correction performed in the gamma correction circuitry 12, more particularly, maximum-brightness-level control point data CP0 to CPm. The contents and technical meaning of the maximum-brightness-level control point data CP0 to CPm will be described later in detail.

Additionally, the interface control circuitry 11 supplies a brightness data D_{BRT} specifying the screen brightness level of the OLED display panel 1 (the brightness level of the entire image displayed on the OLED display panel 1) to the gamma correction circuitry 12. In one embodiment, the control data D_{CTRL} received from the host 3 may include the brightness data D_{BRT} and the interface control circuitry 11 may supply the brightness data D_{BRT} included in the control data D_{CTRL} to the gamma correction circuitry 12.

The gamma correction circuitry 12 performs gamma correction on the image data D_{IN} received from the interface control circuitry 11 to generate display data D_{OUT} used to drive the OLED display panel 1. The above-mentioned maximum-brightness-level control point data CP0 to CPm and brightness data D_{BRT} are used in the gamma correction performed in the gamma correction circuitry 12. Details of the gamma correction performed in the gamma correction circuitry 12 will be described later. In various embodiments, in place of the image data D_{IN}, image data obtained by performing digital processing (such as scaling (image enlargement and shrinkage) and color adjustment) on the image data D_{IN} received from the interface control circuitry 11 may be supplied to the gamma correction circuitry 12.

The latch circuitry 13 latches the display data D_{OUT} output from the gamma correction circuitry 12 and forwards the latched display data D_{OUT} to the data line drive circuitry 15.

The linear grayscale voltage generator circuitry 14 generates a set of grayscale voltages respectively corresponding to the allowed data values of the display data D_{OUT}. In this embodiment, the linear grayscale voltage generator circuitry 14 generates the set of grayscale voltages so that voltage level intervals between adjacent grayscale voltages are the same. In other words, the correspondence relationship between the data values described in the display data D_{OUT} and the corresponding grayscale voltages is linear in this embodiment.

The data line drive circuitry 15 drives the respective data lines 5 with the grayscale voltages corresponding to the data values described in the display data D_{OUT}. More specifically, the data line drive circuitry 15 selects the grayscale voltages corresponding to the data values of the display data D_{OUT} from among the grayscale voltages received from the linear grayscale voltage generator circuitry 14 and drives the respective data lines 5 to the selected grayscale voltages.

Next, a description is given of the operation of the gamma correction circuitry 12 according to one or more embodiments. In one embodiment, when the input grayscale value X_IN associated with a subpixel of interest is supplied to the input of the gamma correction circuitry 12, the gamma correction circuitry 12 outputs an output value Y_OUT as the data value of the display data D_{OUT} associated with the subpixel of interest. In this embodiment, the input grayscale value X_IN is an 8-bit data and the output value Y_OUT is a 12-bit data.

In one or more embodiments, the input-output characteristics of the gamma correction performed in the gamma correction circuitry 12, that is, the correspondence relationship between the input grayscale value X_IN and the output value Y_OUT is controlled on the maximum-brightness-level control point data CP0 to CPm and the brightness data D_{BRT}. The maximum-brightness-level control point data CP0 to CPm are a set of data which specify the input-output characteristics of the gamma correction for the case where the screen brightness level is the allowed maximum brightness level, that is, the brightness data D_{BRT} specifies the allowed maximum brightness level.

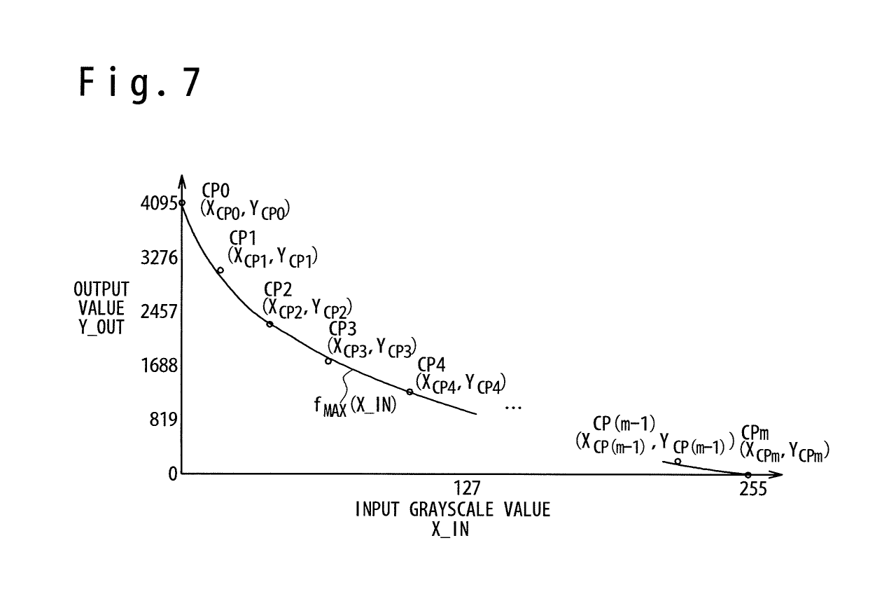

FIG. 7 is a graph schematically illustrating the maximum-brightness-level control point data CP0 to CPm and the input-output characteristics curve determined by the same according to one or more embodiments. The maximum-brightness-level control point data CP0 to CPm specify the coordinates of the control points CP0 to CPm which define the input-output characteristics of the gamma correction in the XY coordinate system in which the X axis represents the input grayscale value X_IN and the Y axis represents the output value Y_OUT, for the case where the screen brightness level is the allowed maximum brightness level. In the embodiment illustrated in FIG. 7, the control point CPi denotes the control point whose coordinates are specified by the maximum-brightness-level control point data CPi, where i is an integer from zero to “m”, and CPi(X_{CPi}, Y_{CPi}) denotes the coordinates of the control point CPi, where X_{CPi} is the X coordinate (the coordinate indicating the position in the X axis direction) of the control point CPi and Y_{CPi} is the Y coordinate (the coordinate indicating the position in the Y axis direction) of the control point CPi. The X coordinate of X_{CPi} of each control point CPi satisfies the condition given below:

X_{CP0}<X_{CP1}< . . . <X_{CPi}<X_{CP(i+1)}< . . . <X_{CP(m-1)}<X_{CPm},

where the X coordinate X_{CP0} of the control point CP0 is the allowed minimum value of the input grayscale value X_IN (that is, zero) and the X coordinate X_{CPm} of the control point CPm is the allowed maximum value of the input grayscale value X_IN (that is, 255).

In various embodiments, when the screen brightness level is the allowed maximum brightness level (that is, the brightness data D_{BRT} specifies the allowed maximum brightness level), the gamma correction circuitry 12 calculates the output value Y_OUT as the Y coordinate of the point which is positioned on the curve defined by the control points CP0 to CPm and has an X coordinate equal to the input grayscale value X_IN. In one embodiment, the gamma correction circuitry 12 may calculate the output value Y_OUT corresponding to the input grayscale value X_IN by using a Bezier curve defined by the control points CP0 to CPm. In this case, the gamma correction circuitry 12 may calculate the output value Y_OUT as the Y coordinate of the point which is positioned on this Bezier curve and has an X coordinate equal to the input grayscale value X_IN.

In one example, the gamma correction circuitry 12 may calculate the output value Y_OUT as the Y coordinate of the point which is positioned on a second order Bezier curve defined by the control points CP0 to CPm and has an X coordinate equal to the input grayscale value X_IN. In one or more embodiments, when the output value Y_OUT is calculated on the basis of a second order Bezier curve, which can be defined with three control points, the gamma correction circuitry 12 may select three control points CP(2k) to CP(2(k+1)) having X coordinates close to the input grayscale value X_IN from among the control points CP0 to CPm, and calculate the output value Y_OUT as the Y coordinate of the point which is positioned on the second order Bezier curve defined by the control points CP(2k) to CP(2(k+1)) and has an X coordinate equal to the input grayscale value X_IN. In one or more embodiments, when a second order Bezier curve is used to calculate the output value Y_OUT, 2p+1 control points CP0 to CPm are defined by the maximum-brightness-level control point data CP0 to CPm, where p is an integer equal to or more than two. In this case, m=2p.

The Bezier curve used to calculate the output value Y_OUT is may not be limited to a second-order Bezier curve. In various embodiments, an n^{th} order Bezier curve can be defined with n+1 control points. Accordingly, when the output value Y_OUT is calculated on the basis of an n^{th} order Bezier curve, the gamma correction circuitry 12 may select n+1 control points CP(k×n) to CP((k+1)×n) having X coordinates close to the input grayscale value X_IN from among the control points CP0 to CPm, and calculate the output value Y_OUT as the Y coordinate of the point which is positioned on the n^{th} order Bezier curve defined by the n+1 control points CP(k×n) to CP((k+1)×n)) and has an X coordinate equal to the input grayscale value X_IN. When an n^{th} order Bezier curve is used to calculate the output value Y_OUT, p×n+1 control points CP0 to CPm are defined by the maximum-brightness-level control point data CP0 to CPm, where p is an integer equal to or more than two. In this case, m=n×p.

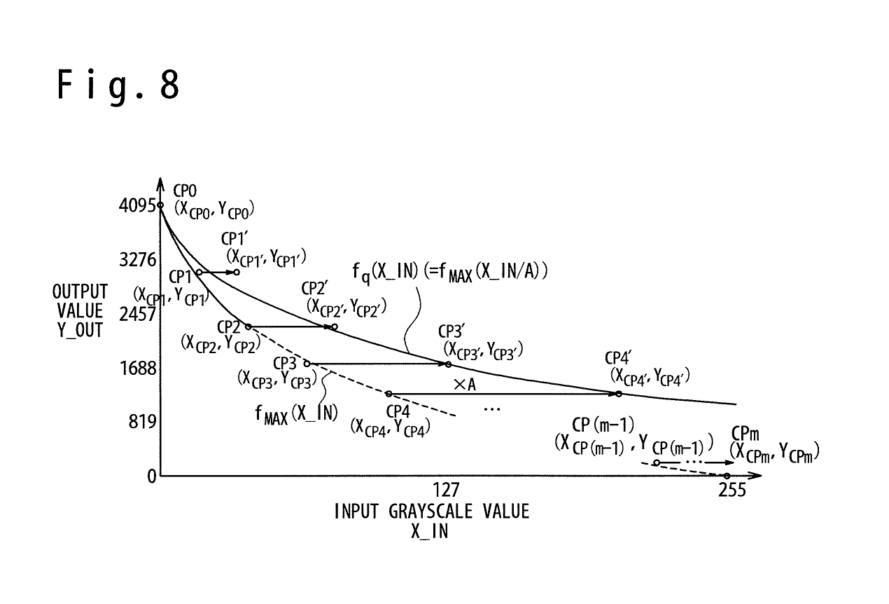

In various embodiments, w the brightness data D_{BRT} specifies a screen brightness level other than the allowed maximum brightness level, as illustrated in FIG. 8. In such embodiments, the gamma correction circuitry 12 calculates the output value Y_OUT under a condition that the input-output characteristics of the gamma correction for the specified screen brightness level is represented by a curve obtained by enlarging the curve defined with the control points CP0 to CPm to A times, where A is a coefficient depending to the ratio q of the screen brightness level specified by the brightness data D_{BRT} to the allowed maximum brightness level. An expression used to obtain the coefficient A will be described later. The gamma correction circuitry 12 calculates the output value Y_OUT as the Y coordinate of the point which is positioned on the curve obtained by enlarging the curve defined with the control points CP0 to CPm to A times and has an X coordinate equal to the input grayscale value X_IN. In other words, in this embodiment, when the input-output characteristics of the gamma correction circuitry 12 for the case where the screen brightness level is the allowed maximum brightness level are represented by the following expression (2a):

Y_OUT=f_{MAX}(X_IN), (2a)

the output value Y_OUT is calculated under a condition that the input-output characteristics of the gamma correction circuitry 12 for the case where the screen brightness level is q times of the allowed maximum brightness level are represented by the following expression (2b):

Y_OUT=f_{MAX}(X_IN/A). (2b)

The curve represented as Y_OUT=f_{MAX}(X_IN/A) can be defined with control points CP0′ to CPm′ obtained by multiplying the X coordinates of the control points CP0 to CPm, and therefore the output value Y_OUT is calculated as the Y coordinate of the point which is positioned on the curve defined with the control points CP0′ to CPm′ and has an X coordinate equal to the input grayscale value X_IN, when the screen brightness level is q times of the allowed maximum brightness level. Since the control points CP0′ to CPm′ are control points actually used in the gamma correction and therefore referred to as correction control points CP0′ to CPm′, hereinafter. The coordinates CPi′ (X_{CPi}′, Y_{CPi}′) of the correction control point CPi′ are obtained from the coordinates CPi (X_{CPi}, Y_{CPi}) of the control points CPi in accordance with the following expressions (3b) and (3c):

X_{CPi}′=A·X_{CPi}, and (3b)

Y_{CPi}′=Y_{CPi}. (3c)

In one example, the gamma correction circuitry 12 may calculate the output value Y_OUT as the Y coordinate of the point which is positioned on a second order Bezier curve defined with the correction control points CP0′ to CPm′ and has an X coordinate equal to the input grayscale value X_IN. It should be noted that the Bezier curve used to calculate the output value Y_OUT is not limited to a second order Bezier curve.

As described above, the coordinate A is determined depending on the ratio q of the screen brightness level specified by the brightness data D_{BRT} to the allowed maximum brightness level. When the gamma value of the display device 10 is γ, the coefficient A satisfies the following expression (4a):

(X_IN/A)^{γ}=q·(X_IN)^{γ}. (4a)

Accordingly, the coefficient A can be determined in accordance with the following expression (4b):

A=1/q^{(1/γ)}. (4b)

When the gamma value γ is 2.2 and q is 0.5 (that is, the screen brightness level is 0.5 times of the allowed maximum brightness level), for example, A is the obtained in accordance with the following expression (4c):

$$\begin{matrix}A = \frac{1}{{( 0.5 )}^{\frac{1}{2.2}}} \\ = \frac{255}{186} .\end{matrix} \qquad ( 4 c )$$

In other words, when the screen brightness level is 0.5 times of the allowed maximum brightness level (a screen brightness level of 50%), the output value Y_OUT is calculated as the Y coordinate of the point which is positioned on the curve specified by the control points CP0′ to CPm′ obtained by multiplying the X coordinates of the control points CP0 to CPm by (255/186) times and has an X coordinate equal to the input grayscale value X_IN. In general, when the screen brightness level is q times of the allowed maximum brightness level, the output value Y_OUT is calculated as the Y coordinate of the point which is positioned on the curve specified by the control points CP0′ to CPm′ obtained by multiplying the X coordinates of the control points CP0 to CPm by 1/q^{(1/γ)} times and has an X coordinate equal to the input grayscale value X_IN.

Next, a description is given of various examples of the configuration of the gamma correction circuitry 12 for achieving the above-described operation.

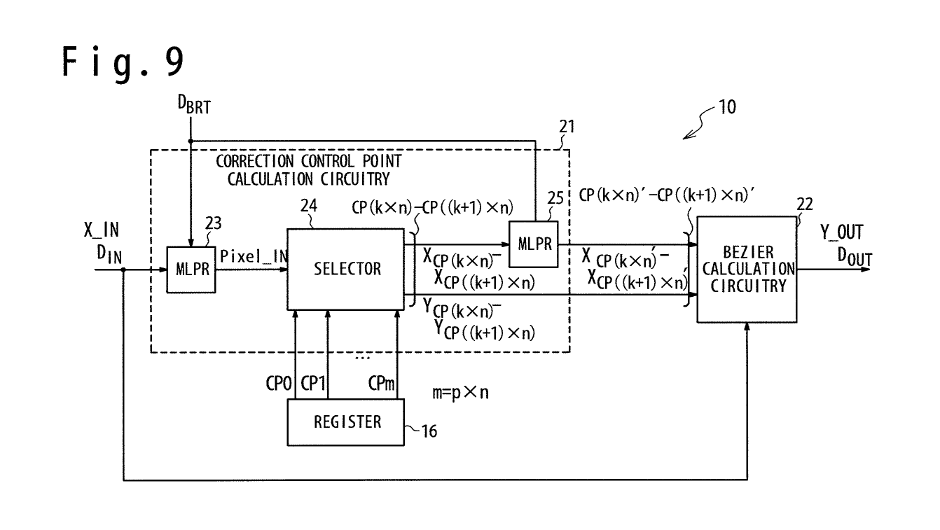

FIG. 9 is a block diagram illustrating the configuration of the gamma correction circuitry 12 in one embodiment. The gamma correction circuitry 12 and the register 16, which stores therein the maximum-brightness-level control point data CP0 to CPm, constitute a correction circuitry which performs the gamma correction. The gamma correction circuitry 12 illustrated in FIG. 9 is configured to calculate the output value Y_OUT from the input grayscale value X_IN using an n^{th} order Bezier curve. In this case, m is p×n, where p is an integer of two or more, and the coordinates of the (p×n+1) control points CP0 to CPm are specified by the maximum-brightness-level control point data CP0 to CPm.

The gamma correction circuitry 12 includes a correction control point calculation circuitry 21 and a Bezier curve calculation circuitry 22. The correction control point calculation circuitry 21 determines n+1 correction control points CP(k×n)′ to CP((k+1)×n)′ used to calculate the output value Y_OUT corresponding to the input grayscale value X_IN from the brightness data D_{BRT}, the input grayscale value X_IN and the maximum-brightness-level control point data CP0 to CPm received from the register 16, where k is an integer from zero to p−1. The Bezier curve calculation circuitry 22 calculates the Y coordinate of the point which is positioned on the n^{th} Bezier curve defined with the n+1 correction control points CP(k×n)′ to CP((k+1)×n)′ and has an X coordinate equal to the input grayscale value X_IN, and outputs the calculated Y coordinate as the output value Y_OUT.

The correction control point calculation circuitry 21 includes a multiplier circuitry 23, a selector 24 and a multiplier circuitry 25. The multiplier circuitry 23 and the selector 24 constitute a select circuitry configured to select (n+1) control points CP(k×n) to CP((k+1)×n) from among the control points CP0 to CPm on the basis of the input grayscale value X_IN and the screen brightness level specified by the brightness data D_{BRT}. More specifically, in various embodiments, the multiplier circuitry 23 calculates a control-point-selecting grayscale value Pixel_in as a value obtained by multiplying the input grayscale value X_IN by the inverse number 1/A of the coefficient A (that is, q^{(1/γ)}). In such embodiments, q is the ratio of the screen brightness level specified by the brightness data D_{BRT} to the allowed maximum brightness level and the coefficient A is given by the above-described expression (4b). The selector 24 selects (n+1) control points CP(k×n) to CP((k+1)×n) from among the control points CP0 to CPm, on the basis of the control-point-selecting grayscale value Pixel_in. In the following, the control points CP(k×n) to CP((k+1)×n) selected by the selector 24 are referred to as the selected control points CP(k×n) to CP((k+1)×n).

In various embodiments, the multiplier circuitry 25 calculates the X coordinates X_{CP(k×n)′} to X_{CP((k+1)×n)}′ of the correction control points CP(k×n)′ to CP((k+1)×n)′ by multiplying the X coordinates X_{CP(k×n)} to X_{CP((k+1)×n)} of the selected control points CP(k×n) to CP((k+1)×n) by A. The Y coordinates Y_{CP(k×n)} to Y_{CP((k+1)×n)} of the selected control points CP(k×n) to CP((k+1)×n) are used as the Y coordinates Y_{CP(k×n)}′ to Y_{CP((k+1)×n)}′ of the correction control points CP(k×n)′ to CP((k+1)×n)′ without modification.

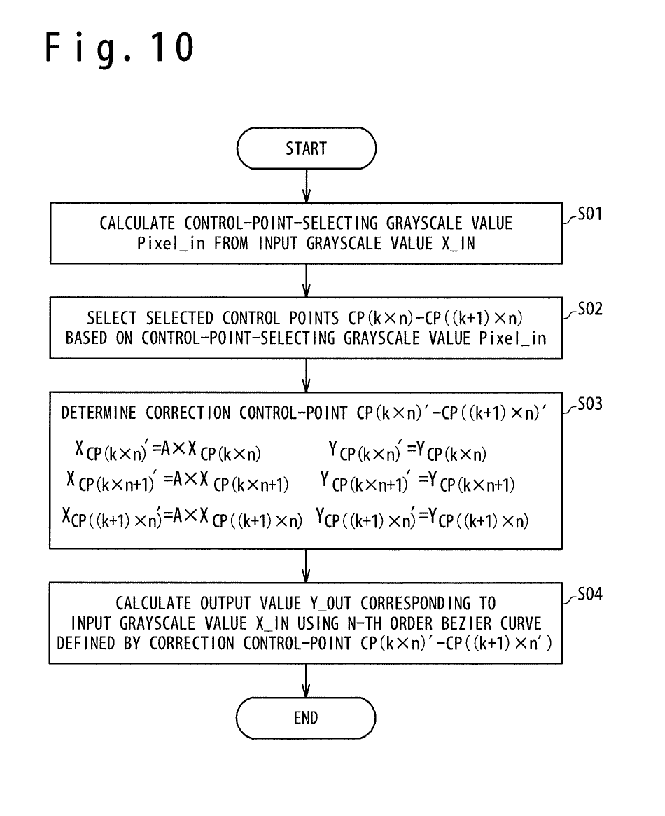

FIG. 10 is a flowchart illustrating an embodiment of the operation of the gamma correction circuitry 12 illustrated in FIG. 9. When an input grayscale value X_IN indicative of the grayscale level of a certain subpixel (a subpixel of interest) is supplied to the gamma correction circuitry 12, a control-point-selecting grayscale value Pixel_in is calculated from the input grayscale value X_IN by the multiplier circuitry 23 at step S01. As described above, the control-point-selecting grayscale value Pixel_in is obtained by multiplying the input grayscale value X_IN by the inverse number 1/A of the coefficient A (that is, by q^{(1/γ)}).

This is followed by selecting n+1 control points CP(k×n) to CP((k+1)×n) from among the control points CP0 to CPm on the basis of the control-point-selecting grayscale value Pixel_in at step S02. The selection of the n+1 control points CP(k×n) to CP((k+1)×n) is achieved by the selector 24. In one or more embodiments, the n+1 control points CP(k×n) to CP((k+1)×n) are selected as follows.

The n^{th} order Bezier curve passes through the control points CP0, CPn, CP(2n), . . . CP(p×n) out of the m+1 (=p×n+1) control points CP0 to CPm. The remaining control points are not necessary positioned on the n^{th} order Bezier curve, although determining the shape of the n^{th} order Bezier curve. The selector 24 compares the control-point-selecting grayscale value Pixel_in with the X coordinates of the control points through which the n^{th} order Bezier curve passes, and selects (n+1) control points CP(k×n) to CP((k+1)×n) in response to the result of the comparison.

In one or more embodiments, when the control-point-selecting grayscale value Pixel_in is larger than the X coordinate of the control point CP0 and smaller than the X coordinate of the control point CPn, the selector 24 selects the control points CP0 to CPn. When the control-point-selecting grayscale value Pixel_in is larger than the X coordinate of the control point CPn and smaller than the X coordinate of the control point CP(2n), the selector 24 selects the control points CPn to CP(2n). In one or more embodiments, when the control-point-selecting grayscale value Pixel_in is larger than the X coordinate X_{CP(k×n)} of the control point CP(k×n) and smaller than the X coordinate X_{CP((k+1)×n)} of the control point CP((k+1)×n), the selector 24 selects the control points CP(k×n) to CP((k+1)×n).

When the control-point-selecting grayscale value Pixel_in is equal to the X coordinate X_{CP(k×n)} of the control point CP(k×n), in one embodiment, the selector 24 selects the control points CP(k×n) to CP((k+1)×n). In such an embodiments, the selector 24 selects the control points CP((p−1)×n) to CP(p×n) when the control-point-selecting grayscale value Pixel_in is equal to the X coordinate of the control point CP(p×n).

In some embodiments, the selector may select the control points CP(k×n) to CP((k+1)×n) when the control-point-selecting grayscale value Pixel_in is equal to the X coordinate X_{CP((k+1)×n)} of the control point CP((k+1)×n). In such embodiments, the selector 24 selects the control points CP0 to CPn when the control-point-selecting grayscale value Pixel_in is equal to the X coordinate of the control point CP0.

Further, in some embodiments, this is followed by determining the correction control points CP(k×n)′ to CP((k+1)×n)′ at step S03. In one embodiment, the X coordinates X_{CP(k×n)}′ to X_{CP((k+1)×n)}′ of the correction control points CP(k×n)′ to CP((k+1)×n)′ are calculated as the products of the coefficient A and the X coordinates X_{CP(k×n)} to X_{CP((k+1)×n)} of the selected control points CP(k×n) to CP((k+1)×n), respectively, by the multiplier circuitry 25. In other words, the multiplier circuitry 25 calculates the X coordinates X_{CP(k×n)}′ to X_{CP((k+1)×n)}′ of the correction control points CP(k×n)′ to CP((k+1)×n)′ in accordance with the following expressions (5a):

$$\begin{matrix}{X}_{CP ( k \times n )}^{′} = A \cdot {X}_{CP ( k \times n )} , & ( 5 a ) \\ {X}_{CP ( ( k \times n ) + 1 )}^{′} = A \cdot {X}_{CP ( ( k \times n ) + 1 )} , … , & \\ and & \\ {X}_{CP ( ( k + 1 ) \times n )}^{′} = A \cdot {X}_{CP ( ( k + 1 ) \times n )} . & \end{matrix}$$

The Y coordinates Y_{CP(k×n)}′ to Y_{CP((k+1)×n)}′ of the correction control points CP(k×n)′ to CP((k+1)×n)′ are determined as being equal to the Y coordinates Y_{CP(k×n)} to Y_{CP((k+1)×n)} of the selected control points CP (k×n) to CP((k+1)×n), respectively. In other words, the Y coordinates Y_{CP(k×n)}′ to Y_{CP((k+1)×n)}′ of the correction control points CP(k×n)′ to CP((k+1)×n)′ are represented by the following expressions (5b):

$$\begin{matrix}{Y}_{CP ( k \times n )}^{′} = {Y}_{CP ( k \times n )} , & ( 5 b ) \\ {Y}_{CP ( ( k \times n ) + 1 )}^{′} = {Y}_{CP ( ( k \times n ) + 1 )} , … , & \\ and & \\ {Y}_{CP ( ( k + 1 ) \times n )}^{′} = {Y}_{CP ( ( k + 1 ) \times n )} . & \end{matrix}$$

The X and Y coordinates of the correction control points CP(k×n)′ to CP((k+1)×n)′ thus determined are supplied to the Bezier curve calculation circuitry 22. Further, the output value Y_OUT corresponding to the input grayscale value X_IN is calculated by the Bezier curve calculation circuitry 22 at step S04. The output value Y_OUT is calculated as the Y coordinate of the point which is positioned on the n^{th} order Bezier curve defined with the (n+1) correction control points CP(k×n)′ to CP((k+1)×n)′ and has an X coordinate equal to the input grayscale value X_IN.

Although the above-described embodiment describes the configuration in which the gamma correction circuitry 12 is supplied with the maximum-brightness-level control point data CP0 to CPm, which indicate the coordinates of the control points specifying the input-output characteristics of the gamma correction for the case where the screen brightness level is the allowed maximum brightness level (that is, the case where the brightness data D_{BRT} specifies the allowed maximum brightness level). In one or more embodiments, a set of control point data which indicate the coordinates of control points specifying the input-output characteristics of the gamma correction for the case where the screen brightness level is a specific brightness level (that is, the case where the brightness data D_{BRT} specifies the specific brightness level) may be used in place of the maximum-brightness-level control point data CP0 to CPm. Further, the n+1 correction control points CP(k×n)′ to CP((k+1)×n)′ can be calculated by defining the parameter q, which is included in expression (4b) used to calculate the coefficient A, as the ratio of the brightness level specified by the brightness data D_{BRT} to the specific brightness level.

In various embodiments, the order of the Bezier curve used to calculate the output value Y_OUT may be selected depending to the required preciseness, not limited to a specific order. The use of a second order Bezier curve to calculate the output value Y_OUT however allows calculating the output value Y_OUT accurately while simplifying the configuration of the Bezier curve calculation circuitry 22. In the following, a description is given of an exemplary configuration and operation of the Bezier curve calculation circuitry 22 for the case where the output value Y_OUT is calculated using a second order Bezier curve. In various embodiments, the X and Y coordinates of three correction control points CP(2k)′, CP(2k+1)′ and CP(2k+2)′ are supplied to the inputs of the Bezier curve calculation circuitry 22 when the output value Y_OUT is calculated using a second order Bezier curve.

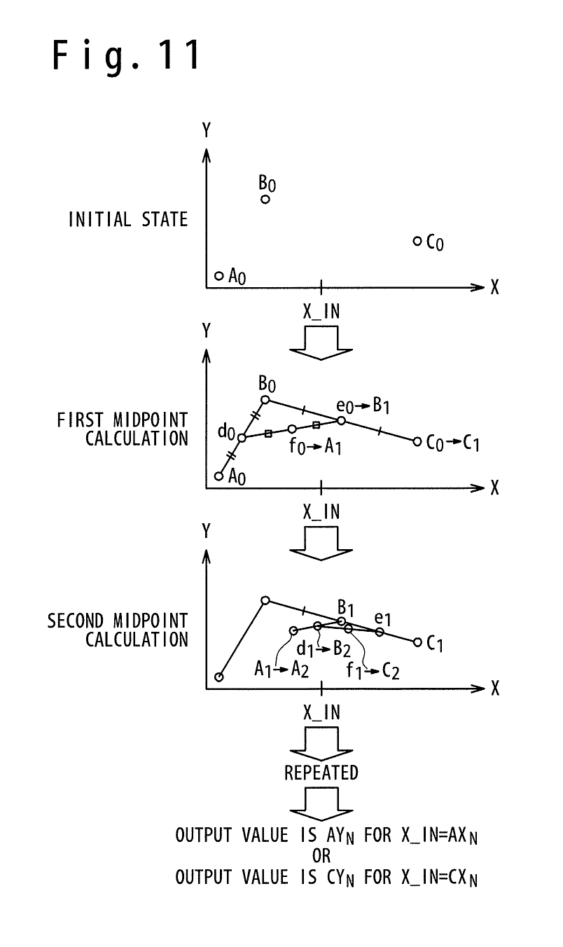

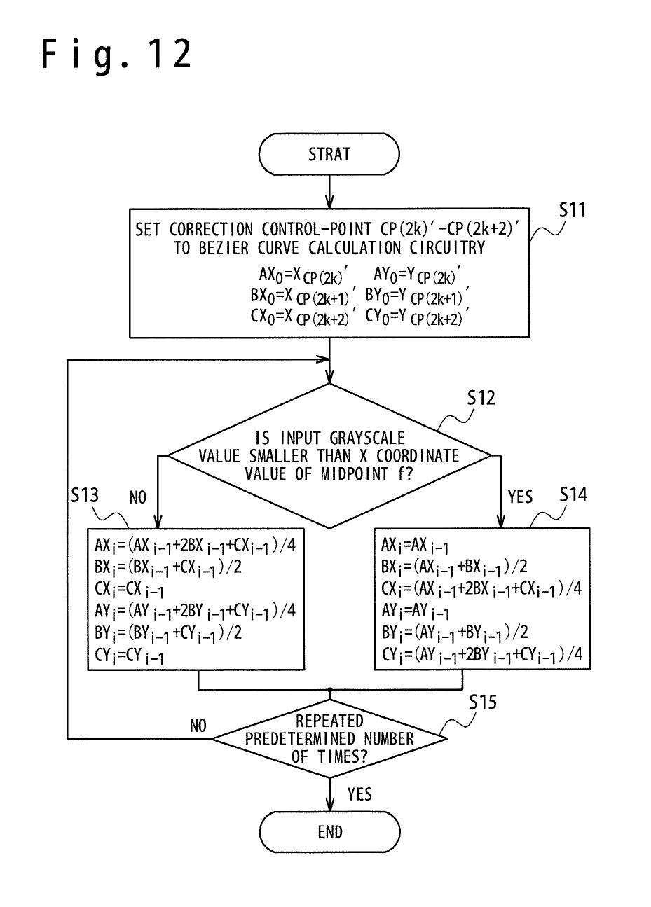

In the following, a description is first given of the calculation algorithm performed in the Bezier curve calculation circuitry 22. FIG. 11 schematically illustrates the calculation algorithm performed in the Bezier curve calculation circuitry 22 in one embodiment and FIG. 12 is a flowchart illustrating the calculation procedure.

As illustrated in FIG. 12, the three correction control points (2k)′ to CP(2k+2)′ are set to the Bezier curve calculation circuitry 22 as initial settings at step S11. For conciseness of the description, the correction control points (2k)′ to CP(2k+2)′ set to the Bezier curve calculation circuitry 22 are hereinafter referred to as control points A₀, B₀ and C₀, respectively. With reference to FIG. 11, the coordinates A₀ (AX₀, AY₀), B₀ (BX₀, BY₀) and C₀(CX₀, CY₀) of the control points A₀, B₀ and C₀ are respectively represented as follows:

A₀(AX₀,AY₀)=(X_{CP(2k)}′,Y_{CP(2k)}′),

B₀(BX₀,BY₀)=(X_{CP(2k+1)}′,Y_{CP(2k+1)}′), and

C₀(CX₀,CY₀)=(X_{CP(2k+2)}′,Y_{CP(2k+2)}′)

As described in the following, the output value Y_OUT may be calculated by repeating calculation of midpoints. One unit of this repeated calculation is referred to as the midpoint calculation, hereinafter. In various embodiments, a midpoint of adjacent two of the three control points may be referred to as the first order midpoint and the midpoint of the two first order midpoints may be referred to as the second order midpoint.

In the first midpoint calculation, with respect to the initially-given control points A₀, B₀ and C₀ (that is, the three correction control points CP(2k)′, CP(2k+1)′ and CP(2k+2)′), a first order midpoint do which is the midpoint of the control points A₀ and B₀ and a first order midpoint e₀ which is the midpoint of the control points B₀ and C₀ are calculated, and a second order midpoint f₀ which is the midpoint of the first order midpoints do and e₀ is further calculated. The second order midpoint f₀ is a point on the Bezier curve defined with the three control points A₀, B₀ and C₀. The coordinates (X_{f0}, Y_{f0}) of the second order midpoint f₀ are represented by the following expressions (6a) and (6b):

X_{f0}=(AX₀+2BX₀+CX₀)/4, and (6a)

Y_{f0}=(AY₀+2BY₀+CY₀)/4. (6b)

Three control points A₁, B₁ and C₁ used for the next midpoint calculation (the second midpoint calculation) are selected from the control point A₀, the first order midpoint do, the second order midpoint f₀, the first order midpoint e₀ and the control point C₀ in response to the result of the comparison between the input grayscale X_IN and the X coordinate X_{f0} of the second order midpoint f₀. In one or more embodiments, the control points A₁, B₁ and C₁ are selected as follows:

When X_{f0}≥X_IN (A)

In this case, the three points having the smallest three X coordinates (the three leftmost points), that is, the control point A₀, the first order midpoint do and the second order midpoint f₀ are selected as the control points A₁, B₁ and C₁. In other words,

A₁=A₀,B₁=d₀, and C₁=f₀. (7a)

When X_{f0}<X_IN (B)

In this case, the three points having the largest three X coordinates (the three rightmost points), that is, the second order midpoint f₀, the first order midpoint e₀ and the control point C₀ are selected as the control points A₁, B₁ and C₁. In other words,

A₁=f₀,B₁=e₀, and C₁=C₀. (7b)

The second midpoint calculation is performed in a similar manner. With respect to the control points A₁, B₁ and C₁, the first order midpoint d₁ of the control points A₁ and B₁ and the first order midpoint e₁ the control points B₁ and C₁ are calculated, and the second order midpoint f₁ of the first order midpoints d₁ and e₁ is further calculated. The second order midpoint f₁ is a point on the desired second-order Bezier curve. Three control points A₂, B₂ and C₂ may be used for the next midpoint calculation (the third midpoint calculation). In one embodiment, the three control points may be selected from the control point A₁, the first order midpoint d₁, the second order midpoint f₁, the first order midpoint e₁ and the control point C₁ in response to the result of the comparison between the input grayscale X_IN and the X coordinate X_{f1} of the second order midpoint f₁.

As is illustrated in FIG. 12, the following calculation is performed in the i^{th} midpoint calculation at steps S12 to S14:

When (AXᵢ₋₁+2BXᵢ₋₁+CXᵢ₋₁)/4≥X_IN, (A)

AXᵢ=AXᵢ₋₁, (8a)

BXᵢ=(AXᵢ₋₁+BXᵢ₋₁)/2, (9a)

CXᵢ=(AXᵢ₋₁+2BXᵢ₋₁+CXᵢ₋₁)/4, (10a)

AYᵢ=AYᵢ₋₁, (11a)

BYᵢ=(AYᵢ₋₁+BYᵢ₋₁)/2, and (12a)

CYᵢ=(AYᵢ₋₁+2BYᵢ₋₁+CYᵢ₋₁)/4. (13a)

When (AXᵢ₋₁+2BXᵢ₋₁+CXᵢ₋₁)/4<X_IN, (B)

AXᵢ=(AXᵢ₋₁+2BXᵢ₋₁+CXᵢ₋₁)/4, (8b)

BXᵢ=(BXᵢ₋₁+CXᵢ₋₁)/2, (9b)

CXᵢ=CXᵢ₋₁, (10b)

AYᵢ=(AYᵢ₋₁+2BYᵢ₋₁+CYᵢ₋₁)/4, (11b)

BYᵢ=(BYᵢ₋₁+CYᵢ₋₁)/2, and (12b)

CYᵢ=CYᵢ₋₁. (13b)

It would be apparent to a person skilled in the art that the equal sign may be attached to any one of the inequality signs recited in conditions (A) and (B).

The midpoint calculation is repeated a desired number of times in a similar manner at step S15.

In various embodiments, when a midpoint calculation is performed, the control points Aᵢ, Bᵢ and Cᵢ approach the second order Bezier curve and the X coordinates of the control points Aᵢ, Bᵢ and Cᵢ also approach the input grayscale value X_IN. The output value Y_OUT is finally obtained from the Y coordinate of at least one of the control points A_{N}, B_{N} and C_{N} obtained through the N^{th} midpoint calculation. For example, the output value Y_OUT may be determined as the Y coordinate of an arbitrarily-selected one of the control points A_{N}, B_{N} and C_{N}. Alternatively, the output value Y_OUT may be determined as the average value of the Y coordinates of the control points A_{N}, B_{N} and C_{N}.

In various embodiments, when the number of times N of the midpoint calculations is relatively small, the preciseness of the output value Y_OUT can be improved by increasing the number of times N of the midpoint calculations. In various embodiments, once the number of times N of the midpoint calculations reaches the number of bits of the output value Y_OUT, the preciseness of the output value Y_OUT is not further improved thereafter. In one embodiment, the number of times N of the midpoint calculations is equal to the number of bits of the output value Y_OUT. For example, in this embodiment, in which the output value Y_OUT is a 12-bit data, the number of times N of the midpoint calculations may be 12.

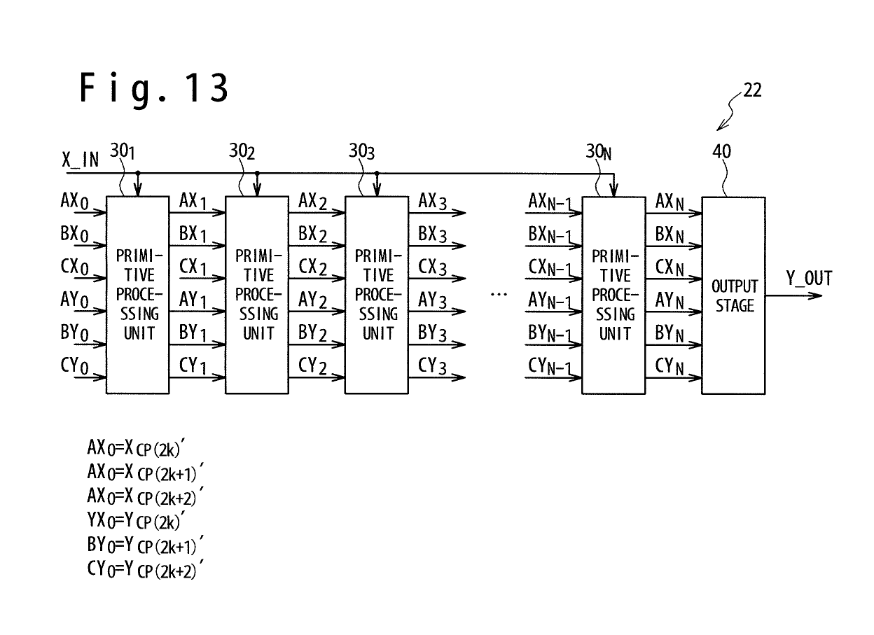

Since the output value Y_OUT is calculated through repeated midpoint calculations as described above, the Bezier curve calculation circuitry 22 may be configured as a plurality of serially-connected processing circuitries each configured to perform the midpoint calculation. FIG. 13 is a block diagram illustrating one example of the configuration of the Bezier curve calculation circuitry 22 thus configured.

The Bezier curve calculation circuitry 22 includes N primitive processing units 30₁ to 30_{N} and an output stage 40. Each of the primitive processing units 30₁ to 30_{N} is configured to perform the above-described midpoint calculation. In other words, the primitive processing unit 30ᵢ is configured to calculate the X and Y coordinates of the control points Aᵢ, Bᵢ and Cᵢ from the X and Y coordinates of the control points Aᵢ₋₁, Bᵢ₋₁ and Cᵢ₋₁ through calculations in accordance with expressions (8a) to (13a) and (8b) to (13b), where i is an integer from one to N. The output stage 40 outputs the output value Y_OUT on the basis of the Y coordinate of at least one control point selected from the control points A_{N}, B_{N} and C_{N}, which is output from the primitive processing unit 30_{N} (that is, on the basis of at least one of AY_{N}, BY_{N} and CY_{N}). The output stage 40 may output the Y coordinate of a selected one of the control points A_{N}, B_{N} and C_{N} as the output value Y_OUT.

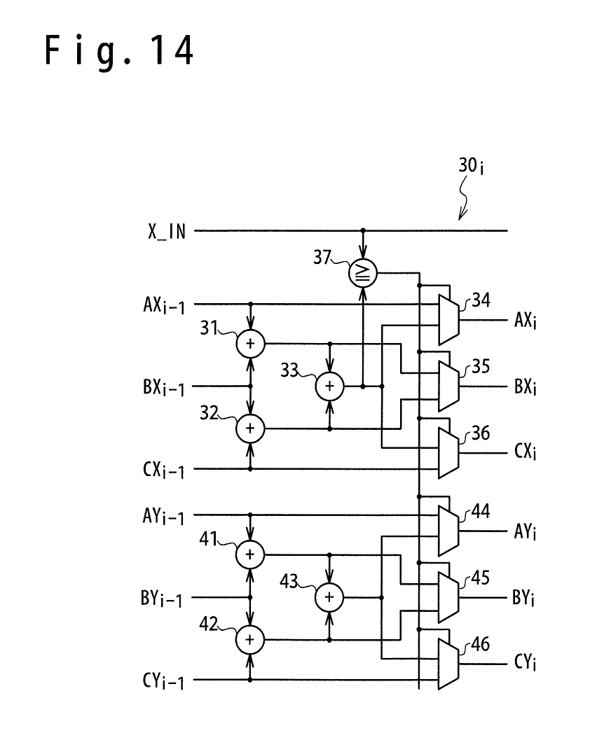

FIG. 14 is a circuit diagram illustrating the configuration of each primitive processing unit 30ᵢ. Each primitive processing unit 30 includes adders 31 to 33, selectors 34 to 36, a comparator 37, adders 41 to 43, and selectors 44 to 46. The adders 31 to 33 and the selectors 34 to 36 perform calculations on the X coordinates of the control points Aᵢ₋₁, Bᵢ₋₁, and Cᵢ₋₁ and the adders 41 to 43 and the selectors 44 to 46 perform calculations on the Y coordinates of the control points Aᵢ₋₁, Bᵢ₋₁, and Cᵢ₋₁.

In one embodiment, each primitive processing unit 30ᵢ includes seven input terminals. One of the seven input terminal receives the input grayscale value X_IN, and the remaining six receive the X coordinates AXᵢ₋₁, BXᵢ₋₁ and CXᵢ₋₁ and Y coordinates AYᵢ₋₁, BYᵢ₋₁ and CYᵢ₋₁ of the control points Aᵢ₋₁, Bᵢ₋₁ and Cᵢ₋₁, respectively. The adder 31 has a first input connected to the input terminal to which AXᵢ₋₁ is supplied and a second input connected to the input terminal to which BXᵢ₋₁ is supplied. The adder 32 has a first input connected to the input terminal to which BXᵢ₋₁ is supplied and a second input connected to the input terminal to which CXᵢ₋₁ is supplied. The adder 33 has a first input connected to the output of the adder 31 and a second input connected to the output of the adder 32.

Similarly, the adder 41 has a first input connected to the input terminal to which AYᵢ₋₁ is supplied and a second input connected to the input terminal to which BYᵢ₋₁ is supplied. The adder 42 has a first input connected to the input terminal to which BYᵢ₋₁ is supplied and a second input connected to the input terminal to which CYᵢ₋₁ is supplied. The adder 43 has a first input connected to the output of the adder 41 and a second input connected to the output of the adder 42.

The comparator 37 has a first input to which the input gray-level value X_IN is supplied and a second input connected to the output of the adder 33.

The selector 34 has a first input connected to the input terminal to which AXᵢ₋₁ is supplied and a second input connected to the output of the adder 33, and selects the first or second input in response to the output value of the comparator 37. The output of the selector 34 is connected to the output terminal from which AXᵢ is output. Similarly, the selector 35 has a first input connected to the output of the adder 31 and a second input connected to the output of the adder 32, and selects the first or second input in response to the output value of the comparator 37. The output of the selector 35 is connected to the output terminal from which BXᵢ is output. Furthermore, the selector 36 has a first input connected to the output of the adder 33 and a second input connected to the input terminal to which Cᵢ₋₁ is supplied, and selects the first or second input in response to the output value of the comparator 37. The output of the selector 36 is connected to the output terminal from which CXᵢ is output.

In one embodiment, the selector 44 has a first input connected to the input terminal to which AYᵢ₋₁ is supplied and a second input connected to the output of the adder 43, and selects the first or second input in response to an output value of the comparator 37. The output of the selector 44 is connected to the output terminal from AYᵢ is output. Similarly, the selector 45 has a first input connected to the output of the adder 41 and a second input connected to the output of the adder 42, and selects the first or second input in response to the output value of the comparator 37. The output of the selector 45 is connected to the output terminal from which BYᵢ is output. Furthermore, the selector 46 has a first input connected to the output of the adder 43 and a second input connected to the input terminal to which CYᵢ₋₁ is supplied, and selects the first or second input in response to the output value of the comparator 37. The output of the selector 46 is connected to the output terminal from which CYᵢ is output.

In the primitive processing unit 30ᵢ thus configured, the adder 31 performs the calculation in accordance with the above-described expression (9a), the adder 32 performs the calculation in accordance with the above-described expression (9b), and the adder 33 performs the calculation in accordance with (10a) and (8b) using the output values from the adders 31 and 32. Similarly, the adder 41 performs the calculation in accordance with the above-described expression (12a), the adder 42 performs the calculation in accordance with the expression (12b), and the adder 43 performs the calculation in accordance with expressions (13a) and (11b) using the output values from the adders 41 and 42. The comparator 37 compares the output value of the adder 33 with the input grayscale value X_IN, and indicates which of the two input values supplied to each of the selectors 34 to 36 and 44 to 46 is to be output as the output value. When the input grayscale value X_IN is smaller than (AXᵢ₋₁+2BXᵢ₋₁+CXᵢ₋₁)/4, the selector 34 selects AXᵢ₋₁, the selector 35 selects the output value of the adder 31, the selector 36 selects the output value of the adder 33, the selector 44 selects AYᵢ₋₁, the selector 45 selects the output value of the adder 41, and the selector 46 selects the output value of the adder 43. When the input gray-level value X_IN is larger than (AXᵢ₋₁+2BXᵢ₋₁+CXᵢ₋₁)/4, the selector 34 selects the output value of the adder 33, the selector 35 selects the output value of the adder 32, the selector 36 selects the CXᵢ₋₁, the selector 44 selects the output value of the adder 43, the selector 45 selects the output value of the adder 42, and the selector 46 selects CYᵢ₋₁. The values selected by the selectors 34 to 36 and 44 to 46 are supplied to the primitive processing unit of the following stage as AXᵢ, BXᵢ, CXᵢ, AYᵢ, BYᵢ, and CYᵢ, respectively.

In various embodiments the divisions described within expressions (8a) to (13a) and (8b) to (13b) can be realized by truncating lower bits. Most simply, desired calculations can be achieved by truncating lower bits of the outputs of the adders 31 to 33 and 41 to 43. In this case, one bit may be truncated from each of the output terminals of the adders 31 to 33 and 41 to 43. It should be noted however that the positions where the lower bits are truncated in the circuitry may be arbitrarily modified as long as calculations equivalent to the expressions (8a) to (13a) and (8b) to (13b) are achieved. For example, lower bits may be truncated at the input terminals of the adders 31 to 33 and 41 to 43 or on the input terminals of the comparator 37, the selectors 34 to 36 and the selectors 44 to 46.

The output value Y_OUT is finally obtained from at least one of AY_{N}, BY_{N} and CY_{N} output from the primitive processing unit 30_{N}, which is the final stage of the serially-connected primitive processing units 30₁ to 30_{N} thus configured.

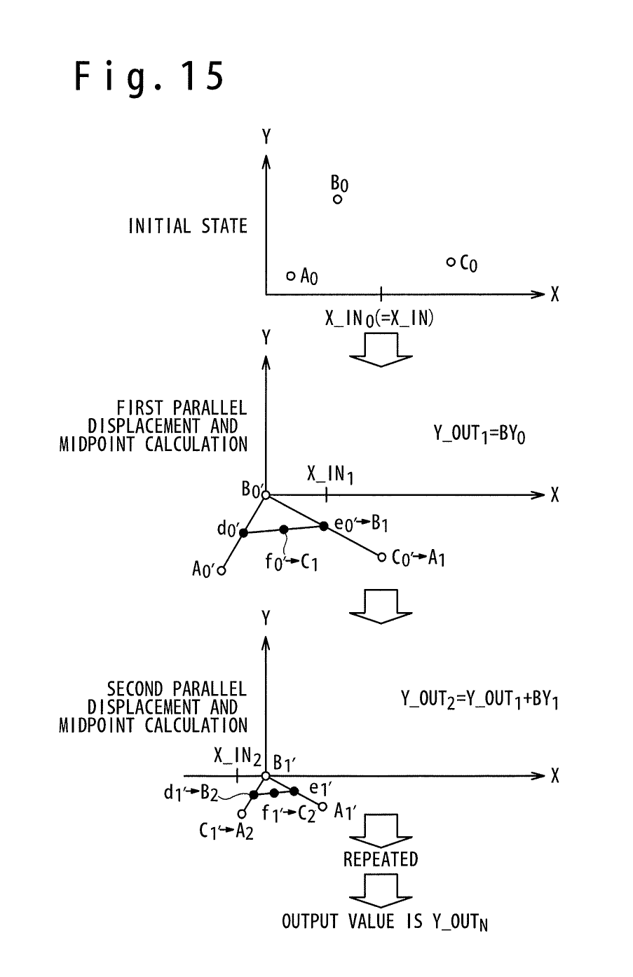

FIG. 15 schematically illustrates an improved algorithm for calculating the output value Y_OUT when a second degree Bezier curve is used for calculating the output value Y_OUT. In the algorithm illustrated in FIG. 15, i^{th} midpoint calculation involves calculating the first order midpoints dᵢ₋₁, eᵢ₋₁ and the second order midpoint fᵢ₋₁ after the control points Aᵢ₋₁, Bᵢ₋₁ and Cᵢ₋₁ are subjected to parallel displacement so that the point Bᵢ₋₁ is shifted to the origin. Additionally, the second order midpoint fᵢ₋₁ is always selected as the point Cᵢ used in the (i+1)^{th} midpoint calculation. The repetition of such parallel displacement and midpoint calculation effectively reduces the number of required processing units and the number of bits of the values processed by the respective processing units.

With reference to FIG. 15, in the first parallel displacement and midpoint calculation, the control points A_{O}, B_{O} and C_{O} are subjected to parallel displacement so that the control point B_{O} is shifted to the origin. The control points A_{O}, B_{O} and C_{O} after the parallel displacement are referred to as the control points A_{O}′, B_{O}′ and C_{O}′, respectively. The control point B_{O}′ coincides with the origin. Here, the coordinates of the control points A₀′ and C₀′ are represented as follows, respectively:

A_{O}′(AX_{O}′,AY_{O}′)=(AX_{O}−BX_{O},AY_{O}−BY_{O}), and

C_{O}′(CX_{O}′,CY_{O}′)=(CX_{O}−BX_{O},CY_{O}−BY_{O})

Meanwhile, the parallel displacement distance BX_{O} in the X axis direction is subtracted from an initial processing target grayscale value X_IN_{O} to obtain a processing target grayscale value X_IN₁, where the initial processing target grayscale value X_IN_{O} is equal to the input grayscale value X_IN.

Next, the first order midpoint d_{O}′ of the control points A_{O}′ and B_{O}′ and the first order midpoint e_{O}′ of the control points B_{O}‘ and C_{O}’ are calculated, and the second order midpoint f_{O}′ of the first order midpoints e_{O}′ and f_{O}′ is further calculated. The second order midpoint f_{O}′ is positioned on the second degree Bezier curve obtained by such parallel displacement that the control point B₀ is shifted to the origin (that is, the second degree Bezier curve defined with the three control points A_{O}′, B_{O}′ and C_{O}′).

In this case, the coordinates (X_{fO}′, Y_{fO}′) of the second order midpoint f_{O}′ are represented by the following expression:

$$\begin{matrix}( {X}_{f 0}^{′} , {Y}_{f 0}^{′} ) = ( \frac{{AX}_{0}^{′} + {CX}_{0}^{′}}{4} , \frac{{AY}_{0}^{′} + {CY}_{0}^{′}}{4} ) , \\ = ( \frac{( {AX}_{0} - {BX}_{0} ) + ( {CX}_{0} - {BX}_{0} )}{4} , \\ \frac{( {AY}_{0} - {BY}_{0} ) + ( {CY}_{0} - {BY}_{0} )}{4} ) \\ = ( \frac{{AX}_{0} - 2 {BX}_{0} + {CX}_{0}}{4} , \frac{{AY}_{0} - 2 {BY}_{0} + {CY}_{0}}{4} )\end{matrix} \qquad ( 14 )$$

The three control points A₁, B₁ and C₁ used in next parallel displacement and midpoint calculation (the second parallel displacement and midpoint calculation) are selected from among the point A_{O}′, the first order midpoint d_{O}′, the second order midpoint f_{O}′, the first order midpoint e_{O}′ and the point C_{O}′ in response to the result of comparison of the processing target grayscale value X_IN₁ with the X coordinate value X_{fO}′ of the second order midpoint f_{O}′. In this selection, the second order midpoint f_{O}′ is always selected as the control point C₁ whereas the control points A₁ and B₁ are selected as follows:

When X_{fo}′≥X_IN₁ (A)

In this case, the two points having the smallest two X coordinates (the leftmost two points), that is, the control point A_{O}′ and the first order midpoint d_{O}′ are selected as the control points A₁ and B₁, respectively. In other words,

A₁=A_{O}′,B₁=d_{O}′ and C₁=f_{O}′. (15a)

When X_{fO}<X_IN₁ (B)

In this case, the two points having the largest two X coordinates (the rightmost two points), that is, the control point C_{O}′ and the first order midpoint e_{O}′ are selected as the control points A₁ and B₁, respectively. In other words,

A₁=C_{O}′,B₁=e_{O}′ and C₁=f_{O}′. (15b)

As a whole, in the first parallel displacement and midpoint calculation, the following calculations are performed:

X_IN₁=X_IN₀−BX₀, and (16)

X_{f0}′=(AX₀−2BX₀+CX₀)/4. (17)

When X_{fO}′≥X_IN₁, (A)

$$\begin{matrix}{AX}_{1} = {AX}_{0} - {BX}_{0} , & ( 17 a ) \\ {BX}_{1} = ( {AX}_{0} - {BX}_{0} ) / 2 , & ( 18 a ) \\ \begin{matrix}{CX}_{1} = {X}_{f 0}^{′} \\ = ( {AX}_{0} - 2 {BX}_{0} + {CX}_{0} ) / 4 ,\end{matrix} & ( 19 ) \\ {AY}_{1} = {AY}_{0} - {BY}_{0} , & ( 20 a ) \\ {BY}_{1} = ( {AY}_{0} - {BY}_{0} ) / 2 , and & ( 21 a ) \\ \begin{matrix}{CY}_{1} = {Y}_{f 0}^{′} \\ = ( {AY}_{0} - 2 {BY}_{0} + {CY}_{0} ) / 4.\end{matrix} & ( 22 )\end{matrix}$$

When X_{fO}′<X_IN₁, (B)

AX₁=CX₀−BX₀, (17b)

BX₁=(CX₀−BX₀)/2, (18b)

CX₁=(AY₀−2BY₀+CY₀)/4, (19)

AY₁=CY₀−BY₀, (20b)

BY₁=(CY₀−BY₀)/2, and (21b)

CY₁=(AY₀−2BY₀+CY₀)/4. (22)

It would be apparent to a person skilled in the art that the equal sign may be attached to any one of the inequality signs recited in conditions (A) and (B).

As understood from expressions (17a), (18a), (17b) and (18b), the following relationship may be established irrespectively of which of conditions (A) and (B) is satisfied:

AX₁=2BX₁, and (23)

AY₁=2BY₁. (24)

This implies that there is no need to redundantly calculate or store the coordinates of the control points A₁ and B₁ when the above-described processing is actually implemented. This would be understood from the fact that the control point B₁ is located at the midpoint between the control point A₁ and the origin O as illustrated in FIG. 15. Although a description is given below of an embodiment in which the coordinates of the control point B₁ are calculated, the calculation of the coordinates of the control point A₁ is substantially equivalent to that of the coordinates of the control point B₁.

Similar processing is performed in the second parallel displacement and midpoint calculation. First, the control points A₁, B₁ and C₁ are subjected to such a parallel displacement that the control point B₁ is shifted to the origin. The control points A₁, B₁ and C₁ after the parallel displacement are referred to as the control points A₁′, B₁′ and C₁′, respectively. Additionally, the parallel displacement distance BX₁ in the X axis direction is subtracted from the processing target grayscale value X_IN₁, thereby calculating the processing target grayscale value X_IN₂. Next, the first order midpoint d₁′ of the control points A₁′ and B₁′ and the first order midpoint e₁′ of the control points B₁′ and C₁′ are calculated, and the second order midpoint f₁′ of the first order midpoints d₁′ and e₁′ is further calculated.

Similarly to expressions (16) to (22), the following expressions are obtained:

X_IN₂=X_IN₁−BX₁, and (25)

X_{f1}′=(AX₁−2BX₁+CX₁)/4. (26)

When X_{f1}′≥X_IN₂, (A)

$$\begin{matrix}{AX}_{2} = {AX}_{1} - {BX}_{1} , & ( 27 a ) \\ {BX}_{2} = ( {AX}_{1} - {BX}_{1} ) / 2 , & ( 28 a ) \\ \begin{matrix}{CX}_{2} = {X}_{f 1}^{′} , \\ = ( {AX}_{1} - 2 {BX}_{1} + {CX}_{1} ) / 4 ,\end{matrix} & ( 29 ) \\ {AY}_{2} = {AY}_{1} - {BY}_{1} , & ( 30 a ) \\ {BY}_{2} = ( {AY}_{1} - {BY}_{1} ) / 2 , and & ( 31 a ) \\ \begin{matrix}{CY}_{2} = {Y}_{f 1}^{′} , and \\ = ( {AY}_{1} - 2 {BY}_{1} + {CY}_{1} ) / 4.\end{matrix} & ( 32 )\end{matrix}$$

When X_{f1}′<X_IN₂, (B)

AX₂=CX₁−BX₁, (27b)

BX₂=(CX₁−BX₁)/2, (28b)

CX₂=(AY₁−2BY₁+CY₁)/4, (29)

AY₂=CY₁−BY₁, (30b)

BY₂=(CY₁−BY₁)/2, and (31b)

CY₂=(AY₁−2BY₁+CY₁)/4. (32)

Here, by substituting expression (23) into expressions (28a) and (29) and expression (24) into expressions (31a) and (32), the following expressions are obtained:

$$\begin{matrix}{BX}_{2} = {BX}_{1} / 2 , ( for {CX}_{1} \geq {X\_IN}_{2} ) & ( 33 a ) \\ = ( {CX}_{1} - {BX}_{1} ) / 2 , ( for {CX}_{1} < {X\_IN}_{2} ) & ( 33 b ) \\ {CX}_{2} = {CX}_{1} / 4 , & ( 34 ) \\ {BY}_{2} = {BY}_{1} / 2 , ( for {CX}_{1} \geq {X\_IN}_{2} ) & ( 35 a ) \\ = ( {CY}_{1} - {BY}_{1} ) / 2 , ( for {CX}_{1} < {X\_IN}_{2} ) and & ( 35 b ) \\ {CY}_{2} = {CY}_{1} / 4. & ( 36 )\end{matrix} \qquad$$

It should be noted that in some embodiments, there may be no need to redundantly calculate or store the X coordinate AX₂ and the Y coordinate AY₂ of the control point A₂, since the following relationship is established as is the case of expressions (23) and (24):

AX₂=2BX₂, and (37)

AY₂=2BY₂. (38)

Similar processing is performed in the third and subsequent parallel displacements and midpoint calculations. It would be understood that, similarly to the second parallel displacement and midpoint calculation, the processing performed in the i^{th} parallel displacement and midpoint calculation (for i≥2) is represented by the following expressions:

$$\begin{matrix}{X\_IN}_{i} = {X\_IN}_{i - 1} - {BX}_{i - 1} , & ( 39 ) \\ {BX}_{i} = {BX}_{i - 1} / 2 , ( for {CX}_{i - 1} \geq {X\_IN}_{i} ) & ( 40 a ) \\ = ( {CX}_{i - 1} - {BX}_{i - 1} ) / 2 , ( for {CX}_{i - 1} < {X\_IN}_{i} ) & ( 40 b ) \\ {CX}_{i} = {CX}_{i - 1} / 4 & ( 41 ) \\ {BY}_{i} = {BY}_{i - 1} / 2 , ( for {CX}_{i - 1} \geq {X\_IN}_{i} ) & ( 42 a ) \\ = ( {CY}_{i - 1} - {BY}_{i - 1} ) / 2 , ( for {CX}_{i - 1} < {X\_IN}_{i} ) and & ( 42 b ) \\ {CY}_{i} = {CY}_{i - 1} / 4. & ( 43 )\end{matrix}$$

It would be apparent to a person skilled in the art that the equal sign may be attached to any one of the inequality signs recited in expressions (40a) and (40b) The same goes for expressions (42a) and (42b).

Expressions (41) and (43) imply that the control point Cᵢ is positioned on the segment connecting the origin O to the control point Cᵢ₋₁ and that the distance between the control point Cᵢ and the origin O is a quarter of the length of the segment OCᵢ₋₁. Accordingly, the repetition of the parallel displacement and midpoint calculation makes the control point Cᵢ closer to the origin O. It would be readily understood that this relationship allows simplification of the calculation of coordinates of the control point C₁. It should be also noted that, in various embodiments, there may be no need to calculate or store the coordinates of the points A₂ to A_{N} in the second and following parallel displacements and midpoint calculations similarly to the first parallel displacement and midpoint calculation, since expressions (39) to (43) do not recite the coordinates of the control points A₁ and Aᵢ₋₁.

The output value Y_OUT to be finally calculated by repeating the parallel displacement and midpoint calculation N times is obtained as the Y coordinate value of the control point B_{N} with all the parallel displacements cancelled. Accordingly, the output coordinate value Y_OUT can be calculated the following expression:

Y_OUT=BY₀+BY₁+ . . . +BYᵢ₋₁. (44)

To achieve such processing, the following processing is performed in the i^{th} parallel displacement and midpoint calculation:

Y_OUT₁=BY₀, (for i=1) and

Y_OUTᵢ=Y_OUTᵢ₋₁+BYᵢ₋₁. (for i≥2) (45)

In this case, the output value Y_OUT of interest is obtained as Y_OUT_{N}.

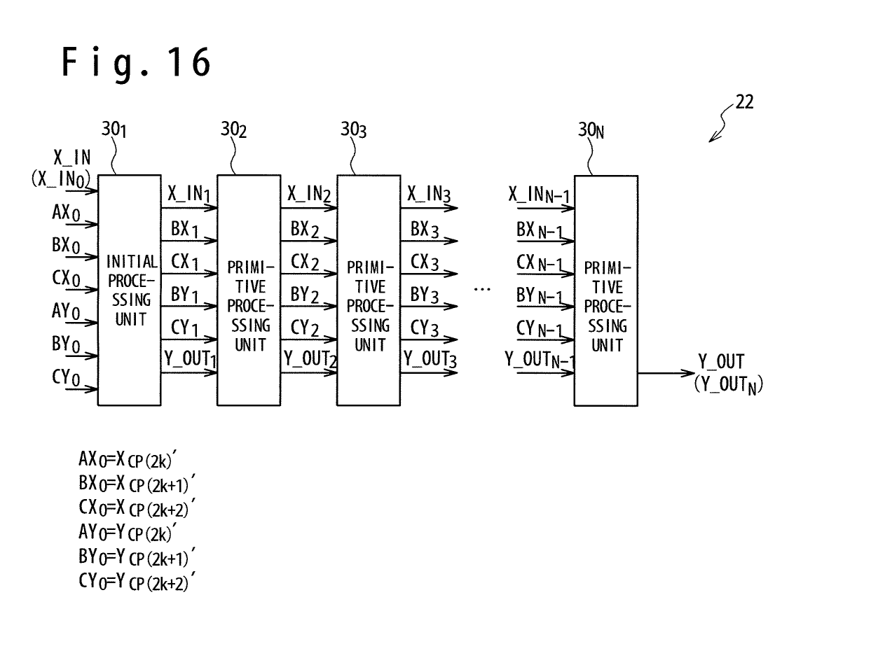

FIG. 16 is a circuit diagram illustrating the configuration of the Bezier curve calculation circuitry 22 in which the parallel displacement and midpoint calculation. The Bezier curve calculation circuitry 22 illustrated in FIG. 16 includes an initial-stage processing unit 50₁ and a plurality of primitive processing units 50₂ to 50_{N} serially connected to the output of the initial-stage processing unit 50₁. The initial-stage processing unit 50₁ has the function of achieving the first parallel displacement and midpoint calculation and is configured to perform the calculations in accordance with expressions (16) to (22). The primitive processing units 50₂ to 50_{N} have the function of achieving the second and following parallel displacements and midpoint calculations and are configured to perform the calculations in accordance with expressions (39) to (43) and (45).

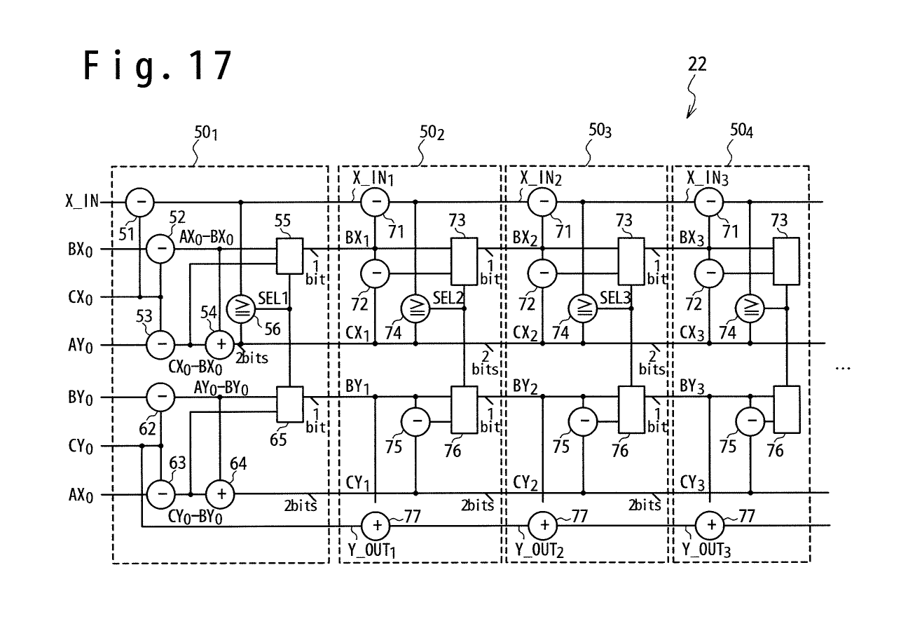

FIG. 17 is a circuit diagram illustrating the configurations of the initial-stage processing unit 50₁ and the primitive processing units 50₂ to 50_{N}. The initial-stage processing unit 50₁ includes subtractors 51 to 53, an adder 54, a selector 55, a comparator 56, subtractors 62 and 63, an adder 64, and a selector 65. The initial-stage processing unit 50₁ has seven input terminals. The input grayscale value X_IN is inputted to one of the input terminals, and the X coordinates AX_{O}, BX_{O} and CX_{O} and Y coordinates AY_{O}, BY_{O}, and CY_{O} of the control points A_{O}, B_{O} and C_{O} are supplied to the other six terminals, respectively.

The subtracter 51 has a first input to which the input grayscale value X_IN is supplied and a second input connected to the input terminal to which BX_{O} is supplied. The subtracter 52 has a first input connected to the input terminal to which AX_{O} is supplied and a second input connected to the input terminal to which BX_{O} is supplied. The subtracter 53 has a first input connected to the input terminal to which CX_{O} is supplied and a second input connected to the input terminal to which BX_{O} is supplied. The adder 54 has a first input connected to the output of the subtracter 52 and a second input connected to the output of the subtracter 53.

Similarly, the subtracter 62 has a first input connected to the input terminal to which AY_{O} is supplied and a second input connected to the input terminal to which BY_{O} is supplied. The subtracter 63 has a first input connected to the input terminal to which CY_{O} is supplied and a second input connected to the input terminal to which BY_{O} is supplied. The adder 64 has a first input connected to the output of the subtracter 62 and a second input connected to the output of the subtracter 63.

The comparator 56 has a first input connected to the output of the subtracter 51 and a second input connected to the output of the adder 54. The selector 55 has a first input connected to the output of the subtracter 52 and a second input connected to the output of the subtracter 53, and selects the first or second input in response to the output value SEL1 of the comparator 56. Furthermore, the selector 65 has a first input connected to the subtracter 62 and a second input connected to the output of the subtracter 63, and selects the first or second input in response to the output value SEL1 of the comparator 56.

The output terminal from which the processing target grayscale value X_IN₁ is outputted is connected to the output of the subtracter 51. The output terminal from which BX₁ is outputted is connected to the output of the selector 55, and the output terminal from which CX₁ is outputted is connected to the output of the adder 54. Furthermore, the output terminal from which BY₁ is outputted is connected to the output of the selector 65, and the output terminal thereof from which CY₁ is outputted is connected to the output of the adder 64.

The subtracter 51 performs the calculation in accordance with expression (16), and the subtracter 52 performs the calculation in accordance with expression (18a). The subtracter 53 performs the calculation in accordance with expression (18b), and the adder 54 performs the calculation in accordance with expression (19) on the basis of the output values of the subtractors 52 and 53. Similarly, the subtracter 62 performs the calculation in accordance with expression (21a). The subtracter 63 performs the calculation in accordance with expression (21b), and the adder 64 performs the calculation in accordance with expression (22) on the basis of the output values of the subtractors 62 and 63. The comparator 56 compares the output value of the subtracter 51 (that is, X_IN_{O}−BX_{O}) with the output value of the adder 54, and instructs the selectors 55 and 65 to select which of the two input values thereof is to be outputted as the output value. In various embodiments, when X_IN₁ is equal to or smaller than (AX_{O}−2BX_{O}+CX_{O})/4, the selector 55 selects the output value of the subtracter 52 and the selector 65 selects the output value of the subtracter 62. Further, when X_IN_{O}−BX_{O} is larger than (AX_{O}−2BX_{O}+CX_{O})/4, the selector 55 selects the output value of the subtracter 53 and the selector 65 selects the output value of the subtracter 63. The values selected by the selectors 55 and 65 are supplied to the primitive processing unit 50₂ as BX₁ and BY₁, respectively. Furthermore, the output values of the adders 54 and 64 are supplied to the primitive processing unit 50₂ as CX₁ and CY₁, respectively.

It should be noted, that in various embodiments, that divisions recited in expressions (16) to (22) can be realized by truncating lower bits. The positions where the lower bits are truncated in the circuit may be arbitrarily modified as long as calculations equivalent to expressions (16) to (22) are performed. The initial-stage processing unit 50₁ illustrated in FIG. 17 is configured to truncate the lowest one bit on the outputs of the selectors 55 and 65 and to truncate the lowest two bits on the outputs of the adders 54 and 64.

Meanwhile, the primitive processing units 50₂ to 50_{N}, which have the same configuration, each include subtractors 71 and 72, a selector 73, a comparator 74, a subtracter 75, a selector 76, and an adder 77.

In the following, a description is given of the primitive processing unit 50ᵢ which performs the i^{th} parallel displacement and midpoint calculation, where i is an integer from two to N. The subtracter 71 has a first input connected to the input terminal to which the processing target grayscale value X_INᵢ₋₁ is supplied, and a second input connected to the input terminal to which BXᵢ₋₁ is supplied. The subtracter 72 has a first input connected to the input terminal to which BXᵢ₋₁ is supplied, and a second input connected to the input terminal to which CXᵢ₋₁ is supplied. The subtracter 75 has a first input connected to the input terminal to which BYᵢ₋₁ is supplied, and a second input connected to the input terminal to which CYᵢ₋₁ is supplied.

The comparator 74 has a first input connected to the output of the subtracter 71 and a second input connected to the input terminal to which CXᵢ₋₁ is supplied.

The selector 73 has a first input connected to the input terminal to which BXᵢ₋₁ is supplied, and a second input connected to the output of the subtracter 72, and selects the first or second input in response to the output value SELi of the comparator 74. Similarly, the selector 76 has a first input connected to the input terminal to which BYᵢ₋₁ is supplied, and a second input connected to the output of the subtracter 75, and selects the first or second input in response to the output value of the comparator 74.

The processing target grayscale value X_INᵢ is output from the output terminal connected to the output of the subtracter 71. BXᵢ is output from the output terminal connected to the output of the selector 73, and CXᵢ is output from the output terminal connected to the input terminal to which CXᵢ is supplied via an interconnection. In this process, the lower two bits of CXᵢ are truncated. Furthermore, BYᵢ is output from the output terminal connected to the output of the selector 73, and CYᵢ is output from the output terminal connected to the input terminal to which CYᵢ₋₁ is supplied via an interconnection. In this process, the lower two bits of CYᵢ₋₁ are truncated.

The adder 77 has a first input connected to the input terminal to which BXᵢ₋₁ is supplied, and a second input connected to the input terminal to which Y_OUTᵢ₋₁ is supplied. It should be noted that, with respect to the primitive processing unit 50₂ which performs the second parallel displacement and midpoint calculation, Y_OUT₁ supplied to the primitive processing unit 50₂ coincides with BY_{O}. Y_OUTᵢ is outputted from the output of the adder 77.

The subtracter 71 performs the calculation in accordance with expression (39), and the subtracter 72 performs the calculation in accordance with expression (40b). The subtracter 75 performs the calculation in accordance with expression (42b), and the adder 77 performs the calculation in accordance with expression (45). The comparator 74 compares the output value X_INᵢ(=X_INᵢ₋₁−BXᵢ₋₁) of the subtracter 71 with CXᵢ₋₁, and instructs the selectors 73 and 76 to select which of the two input values thereof is to be outputted as the output value. When X_INᵢ is equal to or smaller than CXᵢ₋₁, the selector 73 selects BXᵢ₋₁ and the selector 76 selects BYᵢ₋₁. When X_INᵢ is larger than CXᵢ₋₁, on the other hand, the selector 73 selects the output value of the subtracter 72 and the selector 76 selects the output value of the subtracter 75. The values selected by the selectors 73 and 76 are supplied to the next primitive processing unit 50ᵢ₊₁ as BXᵢ and BYᵢ, respectively. Furthermore, the values obtained by truncating the lower two bits of CXᵢ₋₁ and CYᵢ₋₁ are supplied to the next primitive processing unit 50ᵢ₊₁ as CXᵢ and CYᵢ, respectively.

It should be noted here that divisions recited in expressions (40) to (43) can be realized by truncating lower bits. The positions where the lower bits are truncated in the circuit may be arbitrarily modified as long as operations equivalent to Equations (40) to (43) are performed. The primitive processing unit 50ᵢ illustrated in FIG. 17 is configured to truncate the lower one bit on the outputs of the selectors 73 and 76 and to truncate the lower two bits on the interconnections receiving CXᵢ₋₁ and CYᵢ₋₁.

The effect of reduction in the number of the processing elements would be understood from the comparison of the configuration of the primitive processing units 50₂ to 50_{N} illustrated in FIG. 17 with that of the primitive processing units 30₁ to 30_{N} illustrated in FIG. 14. Besides, in the configuration adapted to the parallel displacement and midpoint calculation illustrated in FIG. 17, in which each of the primitive processing units 50₂ to 50_{N} is configured to truncate lower bits, the number of bits of data to be handled is more reduced in latter ones of the primitive processing units 50₂ to 50_{N}. As thus discussed, the configuration adapted to the parallel displacement and midpoint calculation as illustrated in FIG. 17 allows calculating the output value Y_OUT with reduced hardware utilization.

Although the above-described embodiments recite the cases where the output value Y_OUT is calculated using the second degree Bezier curve having the shape specified by three control points, in other embodiments, the output value Y_OUT may be alternatively calculated by using a third or higher degree Bezier curve. When an n^{th} degree Bezier curve is used, the X and Y coordinates of (n+1) correction control points are initially given, and similar midpoint calculations are performed on the (n+1) correction control points to calculate the output value Y_OUT.

In various embodiments, when (n+1) correction control points are given, the midpoint calculation is performed as follows. First order midpoints are each calculated as a midpoint of adjacent two of the (n+1) correction control points. The number of the first order midpoints is n. Further, second order midpoints are each calculated as a midpoint of adjacent two of the n first order midpoints. The number of the second order midpoint is n−1. In the same way, (n−k) (k+1)^{th} order midpoints are each calculated as a midpoint of adjacent two of the (n−k+1) k^{th} order midpoints. This procedure is repeatedly carried out until the single n-th order midpoint is finally calculated. Here, the control point having the smallest X coordinate out of the (n+1) correction control points is referred to as the minimum control point and the control point having the largest X coordinate is referred to as the maximum control point. Similarly, the k^{th} order midpoint having the smallest X coordinate out of the k^{th} order midpoints is referred to as the k^{th} order minimum midpoint and the k^{th} order midpoint having the largest X coordinate is referred to as the k^{th} order maximum midpoint. When the X coordinate value of the n^{th} order midpoint is smaller than the input grayscale value X_IN, the minimum control point, the first to (n−1)^{th} order minimum midpoints and the n-th order midpoint are selected as the (n+1) control points for the next midpoint calculation. When the X coordinate of the n-th order midpoint is larger than the input grayscale value X_IN, the n^{th} order midpoint, the first to (n−1)^{th} order maximum midpoints and the maximum control point are selected as the (n+1) control points for the next midpoint calculation. The output value Y_OUT is calculated on the basis of the Y coordinate of at least one of the (n+1) control points obtained through N times of the midpoint calculation.

For easiness of understanding the following describes a midpoint calculation for the case where n=3, that is, the case where a third degree Bezier curve is used to calculate the output value Y_OUT. In this case, four correction control points CP(3k)′ to CP(3k+3)′ are set to the Bezier curve calculation circuitry 22. In the following, the four correction control points CP(3k)′ to CP(3k+3)′ are simply referred to control points A₀, B₀, C₀ and D₀, and the coordinates of the control points A_{O}, B_{O}, C_{O}, and D_{O} are referred to as (AX_{O}, AY_{O}), (BX_{O}, BY_{O}), (CX_{O}, CY_{O}), and (DX_{O}, DY₀), respectively. The coordinates A₀ (AX₀, AY₀), B₀ (BX₀, BY₀), C₀ (CX₀, CY₀) and D₀(DX₀, DY₀) of the control points A_{O}, B_{O}, C_{O}, and D_{O} are respectively represented as follows:

A₀(AX₀,AY₀)=(X_{CP(3k)}′,Y_{CP(3k)}′),

B₀(BX₀,BY₀)=(X_{CP(3k+1)}′,Y_{CP(3k+1)}′),

C₀(CX₀,CY₀)=(X_{CP(3k+2)}′,Y_{CP(3k+2)}′), and

D₀(DX₀,DY₀)=(X_{CP(3k+3)}′,Y_{CP(3k+3)}′).

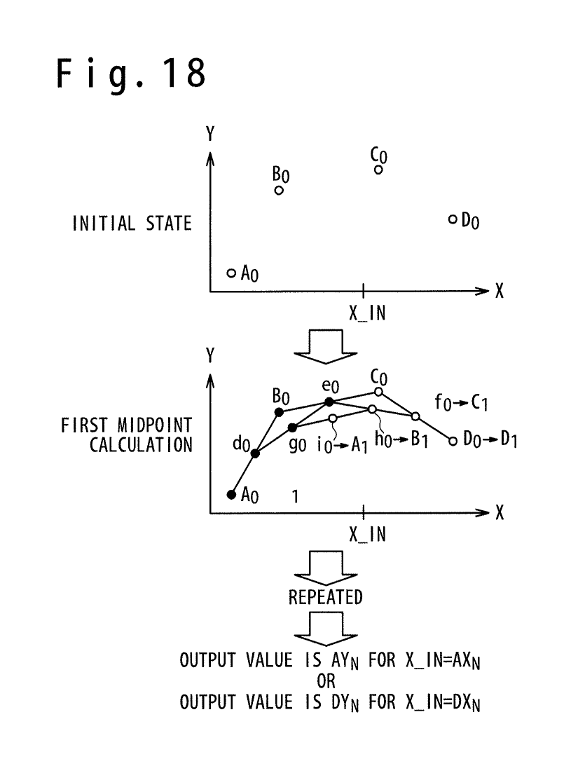

FIG. 18 illustrates the midpoint calculation for n=3 (that is, for the case where the third degree Bezier curve is used to calculate the output value Y_OUT). Initially, four control points A_{O}, B_{O}, C_{O}, and D_{O} are given. It should be noted that the control point A_{O} is the minimum control point and the control point D_{O} is the maximum control point. In the first midpoint calculation, the first order midpoint do that is the midpoint of the control points A_{O} and B_{O}, the first order midpoint e_{O} that is the midpoint of the control points B_{O} and C_{O}, and the first order midpoint f_{O} that is the midpoint of the control points C_{O} and D_{O} are calculated. It should be noted that do is the first order minimum midpoint and that f_{O} is the first order maximum midpoint. The second order midpoint g_{O} that is the midpoint of the first order midpoints do and e_{O} and the second order midpoint h_{O} that is the midpoint of the first order midpoints e_{O} and f_{O} are further calculated. Here, the midpoint g_{O} is the second order minimum midpoint and h_{O} is the second order maximum midpoint. Furthermore, the third order midpoint i_{O} that is the midpoint between the second order midpoints g_{O} and h_{O} is calculated. The third order midpoint i_{O} is a point on the third degree Bezier curve specified by the four control points A_{O}, B_{O}, C_{O} and D_{O}, and the coordinates (X_{iO}, Y_{iO}) of the third order midpoint i_{O} are represented by the following equations, respectively:

X_{iO}=(AX₀+3BX₀+3CX₀+DX₀)/8, and

Y_{iO}=(AY₀+3BY₀+3CY₀+DY₀)/8.

The four control points A₁, B₁, C₁ and D₁ used in the next midpoint calculation (the second midpoint calculation) are selected in response to the result of comparison of the input grayscale value X_IN with the X coordinate X_{iO} of the third order midpoint i_{O}. More specifically, when X_{iO}≥X_IN, the minimum control point A_{O}, the first order minimum midpoint do, the second order minimum midpoint f_{O}, and the third order midpoint e_{O} are selected as the control points A₁, B₁, C₁ and D₁, respectively. When X_{iO}<X_IN, on the other hand, the third order midpoint e_{O}, the second order maximum midpoint h_{O}, the first order maximum midpoint f_{O}, and the maximum control point D_{O} are selected as the control points A₁, B₁, C₁ and D₁, respectively.

The second and subsequent midpoint calculations are performed by the similar procedure. Generally, the following calculations are performed in the i^{th} midpoint calculation:

When (AXᵢ₋₁+3BXᵢ₋₁+3CXᵢ₋₁+DXᵢ₋₁)/8≥X_IN, (A)

AXᵢ=AXᵢ₋₁, (2a′)

BXᵢ=(AXᵢ₋₁+BXᵢ₋₁)/2, (3a′)

CXᵢ=(AXᵢ₋₁+2BXᵢ₋₁+CXᵢ₋₁)/4, (4a′)

DXᵢ=(AXᵢ₋₁+3BXᵢ₋₁+3CXᵢ₋₁+DXᵢ₋₁)/8, (5a′)

AYᵢ=AYᵢ₋₁, (6a′)

BYᵢ=(AYᵢ₋₁+BYᵢ₋₁)/2, (7a′)

CYᵢ=(AYᵢ₋₁+2BYᵢ₋₁+CYᵢ₋₁)/4, and (8a′)

DYᵢ=(AYᵢ₋₁+3BYᵢ₋₁+3CYᵢ₋₁+DYᵢ₋₁)/8. (9a′)

When (AXᵢ₋₁+3BXᵢ₋₁+3CXᵢ₋₁+DXᵢ₋₁)/8<X_IN, (B)

AXᵢ=(AXᵢ₋₁+3BXᵢ₋₁+3CXᵢ₋₁+DXᵢ₋₁)/8, (2b′)

BXᵢ=(BXᵢ₋₁+2CXᵢ₋₁+DXᵢ₋₁)/4, (3b′)

CXᵢ=(CXᵢ₋₁+DXᵢ₋₁)/2, (4b′)

DXᵢ=DXᵢ₋₁, (5b′)

AXᵢ=(AXᵢ₋₁+3BXᵢ₋₁+3CXᵢ₋₁+DXᵢ₋₁)/8, (6b′)

BYᵢ=(BYᵢ₋₁+2CYᵢ₋₁+DYᵢ₋₁)/4, (7b′)

CYᵢ=(CYᵢ₋₁+DYᵢ₋₁)/2, and (8b′)

DYᵢ=DYᵢ₋₁ (9b′)

It would be apparent to a person skilled in the art that the equal sign may be attached to any one of the inequality signs recited in conditions (A) and (B).

Each midpoint calculation makes the control points Aᵢ, Bᵢ, Cᵢ and Dᵢ closer to the third degree Bezier curve, and also makes the X coordinate values of the control points Aᵢ, Bᵢ, Cᵢ and Dᵢ closer to the input grayscale value X_IN. The output value Y_OUT to be finally calculated is obtained from the Y coordinate of at least one of the control points A_{N}, B_{N}, C_{N} and D_{N} obtained by the N-th midpoint calculation. For example, the output value Y_OUT may be determined as the Y coordinate of an arbitrarily-selected one of the control points A_{N}, B_{N}, C_{N} and D_{N}. Alternatively, the output value Y_OUT may be determined as the average value of the Y coordinates of the control points A_{N}, B_{N}, C_{N} and D_{N}.

In a range in which the number of times N of the midpoint calculations is relatively small, the preciseness of the output value Y_OUT is more improved as the number of times N of the midpoint calculations is increased. It should be noted however that, once the number of times N of the midpoint calculations reaches the number of bits of the output value Y_OUT, the preciseness of the voltage data value Y_OUT is not further improved thereafter. In one embodiment, the number of times N of the midpoint calculations may be equal to the number of bits of the voltage data value Y_OUT. In the present embodiment, in which the output value Y_OUT is a 12-bit data, the number of times N of the midpoint calculations may be 12.

Further when the output value Y_OUT is calculated by using an (n+1)^{th} order Bezier curve, the midpoint calculation may be performed after performing parallel displacement on the control points so that one of the control points is shifted to the origin O, similarly to the case where the second-order Bezier curve is used. When the gamma curve is expressed by a third degree Bezier curve, for example, the first to n-th order midpoints are calculated after subjecting the control points to parallel displacement so that the control point Bᵢ₋₁ or Cᵢ₋₁ is shifted to the origin O. Furthermore, either a combination of the control point Aᵢ₋₁′ obtained by the parallel displacement, the first order minimum midpoint, the second order minimum midpoint and the third order midpoint or a combination of the third order midpoint, the second order maximum midpoint, the first order maximum midpoint, and the control point D₋₁′ are selected as the next control points Aᵢ, Bᵢ, Cᵢ and Dᵢ. Also in this case, the number of bits of values processed by each calculating unit is effectively reduced.

Although embodiments of the present disclosure have been specifically described in the above, it would be understood by a person skilled in the art that the technologies of the present disclosure may be implemented with various modifications.

What is claimed is:

1. A display driver, comprising:
a correction circuitry configured to:
calculate a brightness data which specifies a screen brightness level of a self-luminous display panel;
determine, based on the brightness data, correction control points used for correction performed on an input grayscale value for the screen brightness level specified by the brightness data, and
calculate an output value from the input grayscale value with input-output characteristics specified by the correction control points; and
a drive circuitry configured to generate a drive signal driving a light-emitting element of the self-luminous display panel in response to the output value.

2. The display driver according to claim 1, wherein the correction circuitry comprises:
a specific-brightness-level control point data storage circuitry configured to store specific-brightness-level control point data specifying input-output characteristics between the input grayscale value and the output value for a case where the screen brightness level is a specific brightness level;
a correction control point calculation circuitry configured to determine the correction control points based on the brightness data, the input grayscale value and the specific-brightness level control points data; and
a correction calculation circuitry configured to calculate the output value from the input grayscale value with the input-output characteristics specified by the correction control points.

3. The display device according to claim 2, wherein the specific-brightness-level control point data describe, with respect to a coordinate system defined with a first coordinate axis representing the input grayscale value and a second coordinate axis representing the output value; first coordinates specifying positions of specific-brightness-level control points in a direction along the first coordinate axis, and; second coordinates specifying positions of the specific-brightness-level control points in a direction along the second coordinate axis.

4. The display driver according to claim 3, wherein the correction control point calculation circuitry is further configured to:
calculate, based on the brightness data and the first coordinates of the specific-brightness-level control points, third coordinates specifying positions of the correction control points in the direction along the first coordinate axis; and
determine, based on the second coordinates of the specific-brightness-level control points, fourth coordinates specifying positions of the correction control points in the direction along the second coordinate axis.

5. The display driver according to claim 4, wherein the correction control point calculation circuitry is further configured to:
select selected control points from among the specific-brightness-control points based on the brightness data and the input grayscale value, calculate the third coordinates of the correction control points based on the brightness data and the first coordinates of the selected control points; and determine the fourth coordinates of the correction control points as being coincide with the second coordinates of the selected control points.

6. The display driver according to claim 5, wherein the number of the correction control points determined by the correction control point calculation circuitry is n+1, n being an integer of two or more, and
wherein a curve of the input-output characteristics specified by the correction control points is an n^{th} order Bezier curve defined with the correction control points.

7. The display driver according to claim 5, wherein the correction control point calculation circuitry is further configured to calculate the third coordinates of the correction control points as products obtained by multiplying the first coordinates of the selected control points by a predetermined coefficient A, and
wherein the coefficient A is determined in accordance with the following expression:
A=1/q^{(1/γ)},
where q is a ratio of the screen brightness level specified by the brightness data to the specific brightness level and γ is a gamma value set with respect to the self-luminous display panel.

8. The display driver according to claim 7, wherein the specific-brightness-level control points include first to (p×n+1)^{th} control points, p being an integer of two or more,
wherein the first coordinate of an i^{th} control point of the first to (p×n+1)^{th} control points is larger than the first coordinate of an (i−1)^{th} control point of the first to (p×n+1)^{th} control points, i being an integer from one to p×n,
wherein the first coordinate of the first control point is an allowed minimum value of the input grayscale value,
wherein the first coordinate of the (p×n+1)^{th} control point is an allowed maximum value of the input grayscale value, and
wherein the correction control point calculation circuitry is configured to select ((k−1)×n+1)^{th} to (k×n+1)^{th} control points as the selected control points, when a value obtained by multiplying the input grayscale value by an inverse number 1/A of the coefficient A is larger than the first coordinate of the ((k−1)×n+1)^{th} control point and smaller than the first coordinate of the (k×n+1)^{th} control point.

9. The display driver according to claim 6, wherein n is two.

10. A display device, comprising:
a self-luminous display panel in which each pixel circuit includes a light-emitting element; and
a display driver configured to drive the self-luminous display panel, the display driver comprising:
a correction circuitry configured to:
calculate a brightness data which specifies a screen brightness level of a self-luminous display panel;
determine, based on the brightness data, correction control points used for correction performed on an input grayscale value for the screen brightness level specified by the brightness data, and
calculate an output value from the input grayscale value with input-output characteristics specified by the correction control points; and
a drive circuitry configured to generate a drive signal driving the light-emitting element of the self-luminous display panel in response to the output value.

11. The display device according to claim 10, wherein the correction circuitry comprises:
a specific-brightness-level control point data storage circuitry configured to: store specific-brightness-level control point data specifying input-output characteristics between the input grayscale value and the output value for a case where the screen brightness level is a specific brightness level;
a correction control point calculation circuitry configured to: determine the correction control points based on the brightness data, the input grayscale value and the specific-brightness level control points data; and
a correction calculation circuitry configured to: calculate the output value from the input grayscale value with input-output characteristics specified by the correction control points.

12. The display device according to claim 11, wherein the specific-brightness-level control point data describe, with respect to a coordinate system defined with a first coordinate axis representing the input grayscale value and a second coordinate axis representing the output value; first coordinates specifying positions of specific-brightness-level control points in a direction along the first coordinate axis; and second coordinates specifying positions of the specific-brightness-level control points in a direction along the second coordinate axis.

13. The display device according to claim 12, wherein the correction control point calculation circuitry is further configured to: calculate, based on the brightness data and the first coordinates of the specific-brightness-level control points, third coordinates specifying positions of the correction control points in the direction along the first coordinate axis; and determine, based on the second coordinates of the specific-brightness-level control points, fourth coordinates specifying positions of the correction control points in the direction along the second coordinate axis.

14. The display device according to claim 13, wherein the correction control point calculation circuitry is further configured to:
select selected control points from among the specific-brightness-control points based on the brightness data and the input grayscale value;
calculate the third coordinates of the correction control points based on the brightness data and the first coordinates of the selected control points; and
determine the fourth coordinates of the correction control points as being coincide with the second coordinates of the selected control points.

15. The display device according to claim 14, wherein the number of the correction control points determined by the correction control point calculation circuitry is n+1, n being an integer of two or more, and wherein a curve of the input-output characteristics specified by the correction control points is an n^{th} order Bezier curve defined with the correction control points.

16. The display device according to claim 14, wherein the correction control point calculation circuitry is configured to calculate the third coordinates of the correction control points as products obtained by multiplying the first coordinates of the selected control points by a predetermined coefficient A, and
wherein the coefficient A is determined in accordance with the following expression:
A=1/q^{(1/γ)},
where q is a ratio of the screen brightness level specified by the brightness data to the specific brightness level and γ is a gamma value set with respect to the self-luminous display panel.

17. A method, comprising:
calculating a brightness data which specifies a screen brightness level of a self-luminous display panel;
determining, based on the brightness data, correction control points used for correction performed on an input grayscale value for the screen brightness level specified by the brightness data, and
calculating an output value from the input grayscale value with input-output characteristics specified by the correction control points; and
generating a drive signal driving a light-emitting element of the self-luminous display panel in response to the output value.

18. The method according to claim 17, wherein the determining the correction control points comprises:
providing specific-brightness-level control point data specifying input-output characteristics between the input grayscale value and the output value for a case where the screen brightness level is a specific brightness level; and
determining the correction control points based on the brightness data, the input grayscale value and the specific-brightness level control points data.

19. The method according to claim 18, wherein the specific-brightness-level control point data describe, with respect to a coordinate system defined with a first coordinate axis representing the input grayscale value and a second coordinate axis representing the output value: first coordinates specifying positions of specific-brightness-level control points in a direction along the first coordinate axis; and second coordinates specifying positions of the specific-brightness-level control points in a direction along the second coordinate axis.

20. The method according to claim 19, wherein the determining the correction control points comprises:
calculating, based on the brightness data and the first coordinates of the specific-brightness-level control points, third coordinates specifying positions of the correction control points in the direction along the first coordinate axis; and
determining, based on the second coordinates of the specific-brightness-level control points, fourth coordinates specifying positions of the correction control points in the direction along the second coordinate axis.
